(19) United States
(12) Patent Application Publication
(10) Pub. No.: US 2026/0238805 A1
(43) Pub. Date: Aug. 13, 2026

(54) ENCODING AND DECODING METHODS, ENCODER, DECODER AND STORAGE MEDIUM

(71) Applicant: GUANGDONG OPPO MOBILE TELECOMMUNICATIONS CORP., LTD., Dongguan (CN)

(72) Inventors: Vladyslav ZAKHARCHENKO, Dongguan (CN); Yue YU, Dongguan (CN); Haoping YU, Dongguan (CN)

(21) Appl. No.: 19/631,764

(22) Filed: Mar. 27, 2026

Related U.S. Application Data
(63) Continuation of application No. PCT/CN2024/122033, filed on Sep. 27, 2024.
(60) Provisional application No. 63/541,721, filed on Sep. 29, 2023.

(51) Int. Cl. H04N 19/196; H04N 19/124; H04N 19/184; H04N 19/54; H04N 19/70

(52) U.S. Cl. CPC H04N 19/196; H04N 19/124; H04N 19/184; H04N 19/70; H04N 19/54

(57) ABSTRACT

An encoding and decoding method, an encoder, a decoder and a storage medium are provided, the decoding method includes that: a prediction parameter of a current level is decoded from a bitstream; a delta quantization parameter (QP) of the current level is decoded from the bitstream in case that the prediction parameter indicates updating a reference QP of the current level; a reference QP of the current level is updated according to the delta QP, to determine a target QP of the current level; a displacement component is dequantized according to the target QP of the current level, to determine a reconstructed value of the displacement component of the current level.

### CROSS-REFERENCE TO RELATED APPLICATIONS

This is a continuation application of International Patent Application No. PCT/CN2024/122033, filed on Sep. 27, 2024, which is based on and claims priority to U.S. Patent Application No. 63/541,721 filed on Sep. 29, 2023, the contents of which are incorporated herein by reference in their entirety.

### BACKGROUND

In the standard reference software of Dynamic Mesh Coding provided by Moving Picture Experts Group (MPEG), when encoding and decoding geometry information of a mesh, firstly, the original mesh is preprocessed to obtain a base mesh, and the base mesh is encoded by using a general encoding method (e.g., “edgebreaker”). Then, the base mesh is hierarchically subdivided to get a subdivided mesh, and displacement coefficients are obtained according to differences between subdivided points of the subdivided mesh and approximations of the original mesh. Finally, the displacement coefficients are packed into a two-dimensional image and encoded using a lossless video encoding method such as HEVC.

However, in the common encoding methods, encoding of the displacement coefficients causes a high signaling overhead, which affects the performance of mesh compression.

### SUMMARY

Embodiment of the present disclosure relates to the technical field of mesh compression encoding, and in particular to encoding and decoding methods, an encoder, a decoder and a storage medium.

The technical solutions of the embodiments of the present disclosure can be realized as follows:

At a first aspect, embodiments of the present disclosure provide a decoding method applied to a decoder. The method includes the following operations.

A prediction parameter of a current level is decoded from a bitstream.

A delta quantization parameter (QP) of the current level is decoded from the bitstream, in case that the prediction parameter indicates updating a reference QP of the current level.

The reference QP of the current level is updated according to the delta QP, to determine a target QP of the current level.

A displacement component is dequantized according to the target QP of the current level, to determine a reconstructed value of the displacement component of the current level.

At a second aspect, embodiments of the present disclosure provide an encoding method applied to an encoder. The method includes the following operations.

A delta QP of a current level is determined from candidate delta QPs of the current level.

A reference QP of the current level is updated according to the delta QP, to determine a target QP of the current level.

A displacement component is dequantized according to the target QP of the current level, to determine a reconstructed value of the displacement component of the current level.

A cost value of the delta QP is calculated according to the reconstructed value of the displacement component.

An encoding scheme is determined according to the cost value of the delta QP, to determine a prediction parameter of the current level. The prediction parameter indicates whether to update the reference QP of the current level.

The prediction parameter is coded.

In case of determining to update the reference QP of the current level, the delta QP is encoded, and resulted encoded bits are written into the bitstream.

At a third aspect, embodiments of the present disclosure provide a non-transitory computer-readable storage medium having a computer program and a bitstream stored thereon. The computer program, when executed by a processor, enables the processor to perform steps of an encoding method to generate the bitstream. The encoding method includes the following operations.

A delta QP of a current level is determined from candidate delta QPs of the current level.

A reference QP of the current level is updated according to the delta QP, to determine a target QP of the current level.

A displacement component is dequantized according to the target QP of the current level, to determine a reconstructed value of the displacement component of the current level.

A cost value of the delta QP is calculated according to the reconstructed value of the displacement component.

An encoding scheme is determined according to the cost value of the delta QP, to determine a prediction parameter of the current level. The prediction parameter indicates whether to update the reference QP of the current level.

The prediction parameter is coded.

In case of determining to update the reference QP of the current level, the delta QP is encoded, and resulted encoded bits are written into the bitstream.

### BRIEF DESCRIPTION OF THE DRAWINGS

FIG. 1 illustrates an example of a data structure of a mesh with attributes per vertex.

FIG. 2 illustrates an example of a surface represented by a mesh with color characteristics per vertex.

FIG. 3 illustrates an example of a data structure of a mesh having color characteristics per vertex.

FIG. 4 illustrates an example of a data structure by a mesh with attribute mapping characteristics.

FIG. 5 illustrates an example of a surface represented by a mesh having attribute mapping characteristics.

FIG. 6A illustrates an example of a manifold mesh.

FIG. 6B illustrates an example of a non-manifold mesh.

FIG. 7 illustrates an example of a two-stage geometry encoding process.

FIG. 8 illustrates an example of a process of generating a displacement component for one surface in the base mesh.

FIG. 9 illustrates an example of displacement components of mesh vertices.

FIG. 10 illustrates a flowchart of an encoding process for a parameterized mesh.

FIG. 11 illustrates a flowchart of a decoding method according to an embodiment of the present disclosure.

FIGS. 12A and 12B illustrate a flowchart of dequantization of displacement components according to the embodiment of the present disclosure.

FIG. 13 illustrates a flowchart of an encoding method according to the embodiment of the present disclosure.

FIG. 14 illustrates a flowchart of packing of displacement components in embodiments of the present disclosure;

FIG. 15 illustrates a first schematic diagram of LoD-based forward packing for displacement wavelet coefficients in an embodiment of the present disclosure.

FIG. 16 illustrates a first schematic diagram of LoD-based inverse packing of displacement wavelet coefficients in an embodiment of the present disclosure.

FIG. 17 illustrates a second schematic diagram of LoD-based forward packing for displacement wavelet coefficients in an embodiment of the present disclosure.

FIG. 18 illustrates a second schematic diagram of LoD-based inverse packing of displacement wavelet coefficients in an embodiment of the present disclosure.

FIG. 19 illustrates a first schematic diagram of a structure of an encoder according to the embodiment of the present disclosure.

FIG. 20 illustrates a second schematic diagram of a structure of an encoder according to the embodiment of the present disclosure;

FIG. 21 illustrates a first schematic diagram of a structure of a decoder according to the embodiment of the present disclosure.

FIG. 22 illustrates a second schematic diagram of a structure of a decoder according to the embodiment of the present disclosure.

FIG. 23 illustrates a schematic diagram of a structure of a codec according to the embodiment of the present disclosure.

### DETAILED DESCRIPTION

In order to have a more detailed understanding of the features and technical contents of the embodiments of the present disclosure, implementations of the embodiments of the present disclosure will be described in detail below in conjunction with the accompanying drawings, which are for reference only and are not intended to limit the embodiments of the present disclosure.

Unless otherwise defined, all technical and scientific terms used herein have the same meaning as would normally be understood by those skilled in the art of the present disclosure. The terminology used herein is for the purpose of describing embodiments of the application only, and is not intended to limit the present disclosure.

In the following description, reference is made to “some embodiments” that describe a subset of all possible embodiments, but it is understood that “some embodiments” may be the same subset or different subsets of all possible embodiments, and may be combined with each other without conflict.

It should also be noted that the term “first/second/third” referred to in embodiments of the present disclosure is used only to distinguish similar objects and does not represent a particular order for objects, and it is understood that “first/second/third” may be interchanged in a particular order or priority order where permissible to enable embodiments of the present disclosure described herein to be implemented in an order other than that illustrated or described herein.

It should be noted that bitstreams in different data formats can be decoded and synthesized in the same video scene, which may include at least image format, point cloud format and mesh format. In this way, real-time immersive video interaction services can be provided for multiple data formats (e.g., mesh, point cloud, image, etc.) with different sources.

In embodiments of the present disclosure, the data-format-based approach may allow independent processing at the bitstream level of the data format. That is, like tiles or slices in video encoding, different data formats in the scene can be encoded in an independent manner, so that independent encoding and decoding can be performed based on the data format.

Generally speaking, three dimensional (3D) animation content is represented based on key frames. That is, each frame is a static mesh. Static meshes at different times have the same topology and different geometries. However, the data volume of the 3D dynamic mesh based on key frame representation is very large. Therefore, effective storage, transmission and rendering have become a problem to be solved during development of the 3D dynamic mesh. In addition, in order to adapt to different user terminals (computers, notebooks, portable devices, mobile phones), it is necessary to support the spatial scalability of the mesh; and in order to adapt to different network bandwidths (broadband, narrowband, wireless), it is necessary to support the quality scalability of the mesh. Therefore, 3D dynamic mesh compression is a critical problem.

### 1. Key Terms of 3D Dynamic Mesh

Mesh—a collection of vertices, edges, and faces that define the shape/topology of a polyhedral object. The faces usually consist of triangles (triangle mesh).

Base mesh—a mesh with fewer vertexes but preserves similarity to the original surface.

Dynamic mesh—a mesh with at least one of the five components (Connectivity, Geometry, Mapping, Vertex Attribute, and Attribute Map) varying in time.

Animated mesh—a dynamic mesh with constant connectivity.

Parametrized mesh—a mesh with the topology defined as the mapping component.

Connectivity—a set of vertex indices describing how to connect the mesh vertices to create a 3D surface. (Geometry and all the attributes share the same unique connectivity information).

Geometry—a set of vertex 3D (x,y,z) coordinates describing positions associated with the mesh vertices. The (x,y,z) coordinates representing the positions should have finite precision and dynamic range.

Mapping—a description of how to map the mesh surface to 2D regions of the plane. Such mapping is described by a set of UV parametric/texture [mapping] coordinates associated with the mesh vertices together with the connectivity information.

Vertex attribute—a scalar of vector attribute values associated with the mesh vertices.

Attribute Map—attributes associated with the mesh surface and stored as 2D images/videos. The mapping between the videos (i.e., parametric space) and the surface is defined by the mapping information.

Vertex—a position (usually in 3D space) along with other information such as colour, normal vector, and texture coordinates.

Edge—a connection between two vertices.

Face—a closed set of edges in which a triangle face has three edges defined by three vertices. Orientation of the face is determined using a “right-hand” coordinate system.

Surface—a collection of faces that separates the three-dimensional object from the environment.

bpp—bits per point, an amount of information in terms of bits required to describe one point in the mesh.

Displacement—the difference between the original mesh geometry and the mesh geometry reconstructed due to the base mesh subdivision process.

LoD (Level of details)—scalable representation of mesh reconstruction, each level of detail contains enough information to reconstruct mesh to an indicated precision or spatial resolution. Each following level of details is a refinement on top of the plurality of previously reconstructed mesh.

### 2. Related Technology

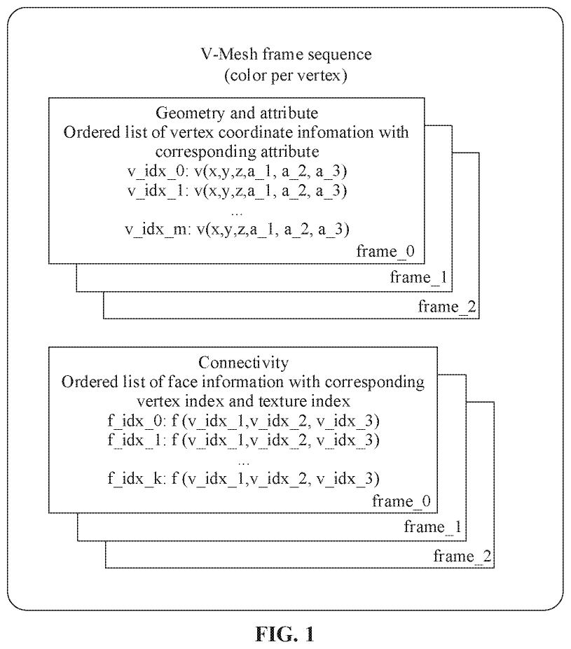

An example of a data structure for a mesh with attributes per vertex is illustrated in FIG. 1.

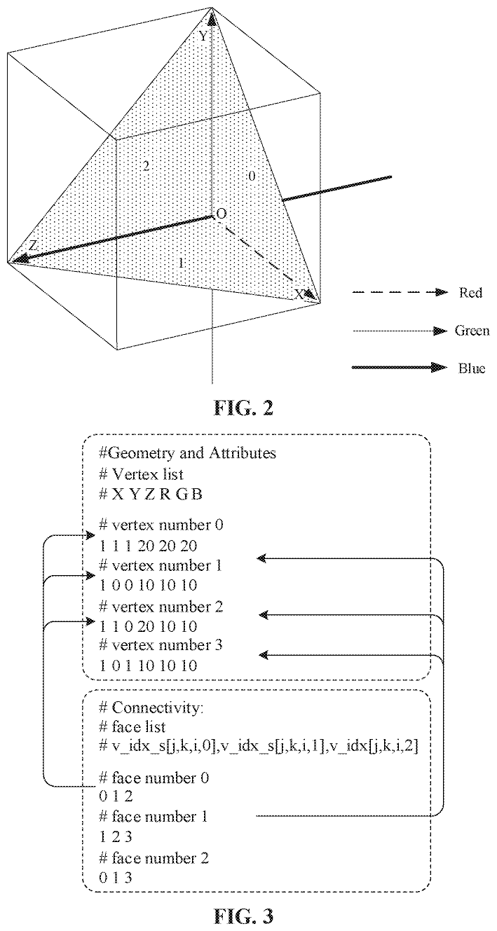

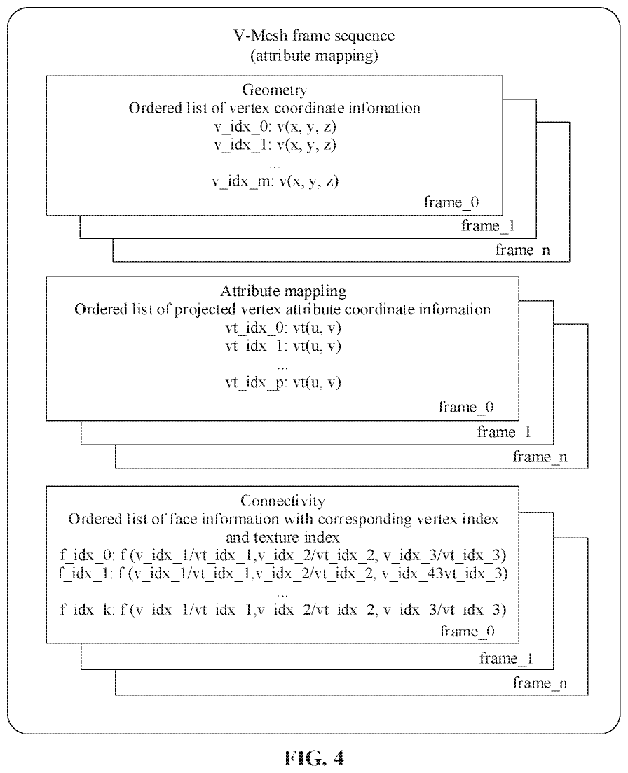

An example of a surface, represented by a mesh with colour-per-vertex characteristics (FIG. 1) is illustrated in FIG. 2. An example of a data structure of the mesh with the colour-per-vertex characteristics is illustrated in FIG. 3. The mesh consists of four vertices and three faces. Each vertex in space is described by its X, Y, Z position coordinates, and three color attributes R, G, B.

As illustrated below, each face is defined by three vertex indices that form a triangle.

# ------------------------------
# Part 1 :
# geometry information
# X Y Z a_1 a_2 a_3
# vertex 0 (v_idx_0)
v 0.0 0.0 0.0 127 127 127
# vertex 1 (v_idx_1)
v 1.0 0.0 0.0 127 127 127
# vertex 2 (v_idx_2)
v 0.0 1.0 0.0 127 127 127
# vertex 3 (v_idx_3)
v 0.0 0.0 1.0 127 127 127
# ------------------------------
# Part 2 :
# connectivity information
# v_idx, v_idx, v_idx
# face 0 (f_idx_0)
f 0 1 2
# face 1 (f_idx_1)
f 0 3 1
# face 2 (f_idx_2)
f 0 2 3
# ------------------------------

An example of a data structure for a mesh with attribute mapping characteristics is illustrated in FIG. 4.

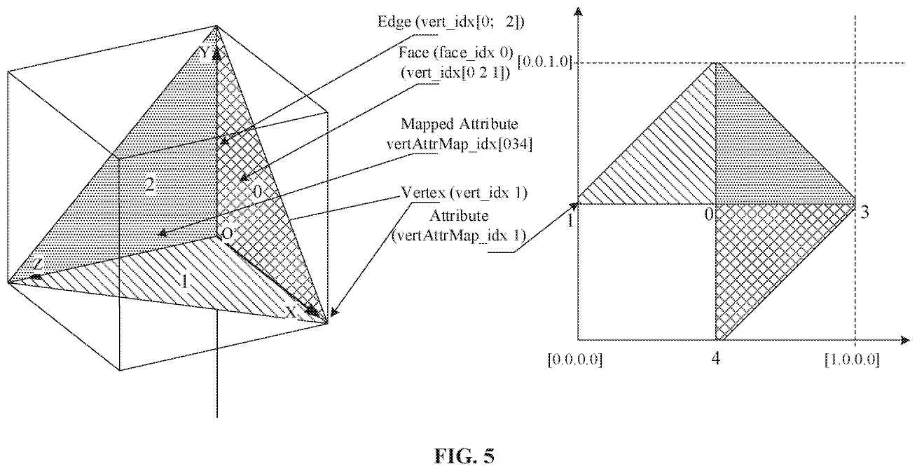

An example of a surface, represented by the mesh with attribute mapping characteristics (FIG. 4) is illustrated in FIG. 5. The mesh consists of four vertices and three faces. Each vertex in space is described by its X, Y, Z position coordinates. (U, V) denotes attribute coordinates in the 2D texture vertex map. Each face is defined by three pairs of vertex indices and texture vertex coordinates that form a triangle in 3D space and a triangle in the 2D texture map.

# ---------------------------------
# Part 1 :
# geometry information
# X Y Z
# vertex 0 (v_idx_0)
v 0.0 0.0 0.0
# vertex 1 (v_idx_1)
v 1.0 0.0 0.0
# vertex 2 (v_idx_2)
v 0.0 1.0 0.0
# vertex 3 (v_idx_3)
v 0.0 0.0 1.0
# ---------------------------------
# Part 2 :
# mapping information
# U V
# texture vertex 0 (vt_0)
vt 0.500000 0.500000
# texture vertex 1 (vt_1)
vt 0.000000 0.500000
# texture vertex 2 (vt_2)
vt 0.500000 1.000000
# texture vertex 3 (vt_3)
vt 1.000000 0.500000
# texture vertex 4 (vt_4)
vt 0.500000 0.000000
# ---------------------------------
# Part 3 :
# connectivity information
# v_idx / vt_idx
# face 0 (f_idx_0)
f 0/0 1/2 2/1
# face 1 (f_idx_1)
f 0/0 3/2 1/3
# face 2 (f_idx_2)
f 0/0 2/3 3/4

The orientation of a face is determined using a right-hand coordinate system. A face consists of three vertices that belong to three edges, and the three vertex indices describe each face.

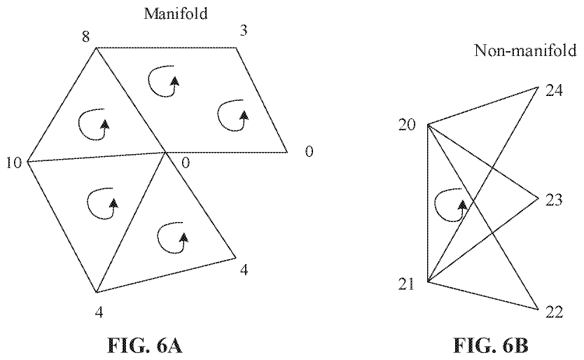

Manifold mesh is a mesh where one edge belongs to two different faces at most, as illustrated in FIG. 6A.

Non-manifold mesh is a mesh with an edge that belongs to more than two faces, as illustrated in FIG. 6B.

Current algorithms apply a two-stage encoding process to encode geometry information. First, the geometry is decimated to create a base mesh encoded using generic geometry encoding methods, e.g., “edgebreaker”. Then the base mesh is hierarchically subdivided, and the difference between the subdivided point and the approximation of the original mesh is stored as the geometry displacement component. The displacement components are packed into a 2D image and encoded with lossless video encoding methods such as HEVC.

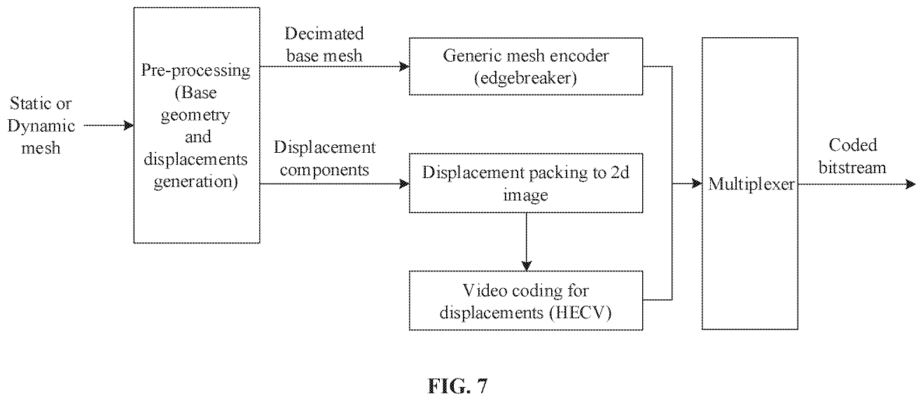

An example of a two-stage geometry encoding process is illustrated in FIG. 7.

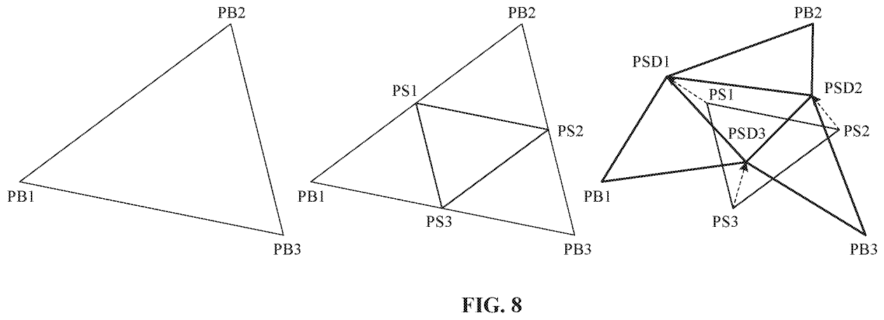

The displacement component generation process for one face in a base mesh with one refinement step is described in FIG. 8. PB1, PB2, and PB3 denote the base mesh points, PS1, PS2, and PS3 represent subdivided points, and PSD1, PSD2, and PSD3 represent displaced subdivided points.

Subdivided point PS1 is calculated as a mid-point between the PB1 and PB2 points. The process can be recursively repeated.

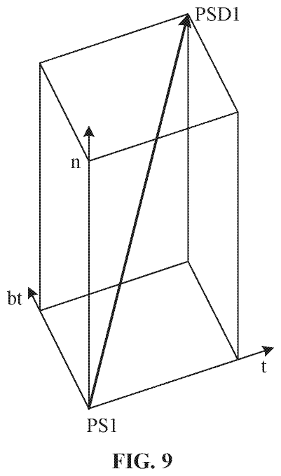

Each vector of PS1 and PSD1 is described by three displacement components in normal, tangent and bitangent directions (FIG. 9) that are further processed with wavelet transform, and the corresponding transform coefficients are mapped to colour planes (e.g., Y, U, and V components in the YUV 444 color-space).

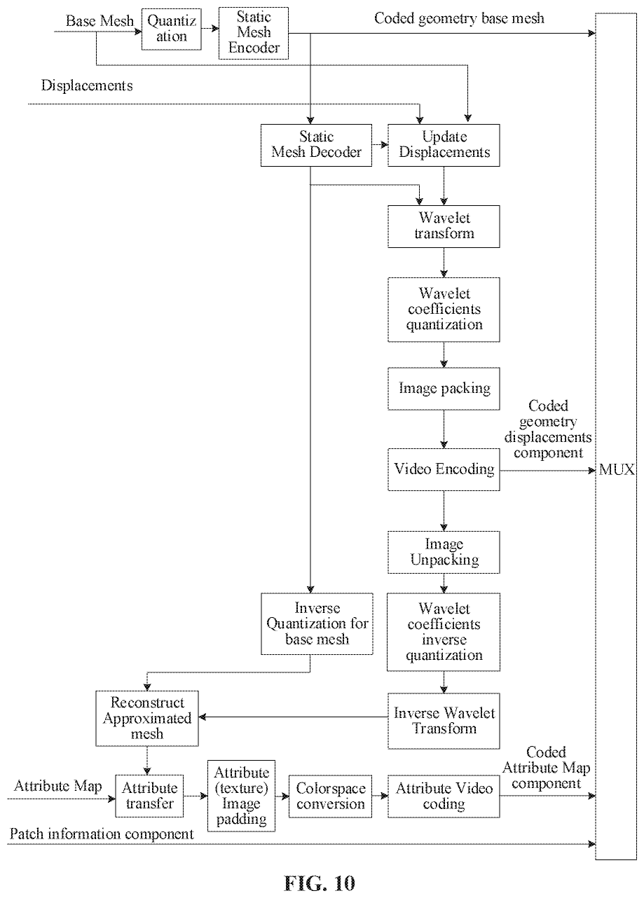

A flowchart describing the encoding process for the parameterized mesh is provided in FIG. 10. The specific encoding process is described as follows.

The base mesh frame is quantized and encoded using a static mesh encoder. The process is agnostic of which mesh encoding scheme is used to compress the base mesh.

The displacements are processed by a hierarchical wavelet (or another) transform that recursively applies refinement layers to the reconstructed base mesh.

The wavelet coefficients are then quantized, packed into a 2D image/video, and can be compressed by using a traditional image/video encoder.

The reconstructed version of the wavelet coefficients is obtained by applying image unpacking and inverse quantization to the reconstructed wavelet coefficient image/video generated during the image/video decoding process.

Reconstructed displacements are then computed by applying the inverse wavelet transform to the reconstructed wavelet coefficients.

Wavelet coefficients are calculated in floating-point format and can be positive and negative. In the current art, to compose a 2D image, the coefficients are first converted to positive and mapped to a given bit-depth.

$${c}^{′} = 2 \hat{} [ bit\_depth - 1 ] + [ c ( i ) * 2 \hat{} bit\_depth ] / [ c\_max - c\_min ] ,$$

where c′(i) is integerized displacement coefficient value, c(i) is a current displacement coefficient, c_max is a maximum displacement coefficient value, c_min is a minimum displacement coefficient value, bit-depth is a value that defines a number of fixed levels for image coding.

Displacement components are transformed using lifting wavelet transform and their corresponding values are quantized according to the value of vmc_transform_lifting_quantization_parameters[ltpIndex][i], and ltpIndex defines an application level 0—sequences; 1—frame; 2—patch; i denotes a corresponding displacement coefficient component (x, y, z for a canonical coordinate system, and n, t, bt for a local coordinate system).

vdmc_lifting_transform_parameters(index, ltpIndex) identifies a set of lifting transform parameters, a bitstream may include one or more sets of lifting transform parameters to choose from, and Index defines a number that corresponds to a set of lifting transform parameters. The structure of the vdmc_lifting_transform_parameters(index, ltpIndex) is illustrated in Table 1.

TABLE 1
Structure of lifting transform parameters

| | Descriptor |
|---|---|
| vdmc_lifting_transform_parameters( index, ltpIndex ){ | |
| vdmc_transform_lifting_skip_update_flag[ index ][ ltpIndex ] | u(1) |
| vdmc_transform_lod_quantization_flag[ index ][ ltpIndex ] | u(1) |
| if( vdmc_transform_lod_quantization_flag[ index ][ ltpIndex ] == 0 ){ | |
| for( j = 0; j < 3; j++) { | |
| vdmc_transform_lifting_quantization_parameters[ index ][ ltpIndex | ue(v) |
| ][ j ] | |
| vdmc_transform_log2_lifting_lod_inverse_scale[ index ][ ltpIndex ][ | ue(v) |
| j ] | |
| } | |
| vdmc_transform_log2_lifting_update_weight[ index ][ ltpIndex ] | ue(v) |
| vdmc_transform_log2_lifting_prediction_weight[ index ][ ltpIndex ] | ue(v) |
| } else { | |
| for( i=0 ; i < afps_vdmc_ext_subdivision_iteration_count + 1; i++ ){ | |
| for( j = 0; j < numDispComp; j++ ) { | |
| s | u(6) |
| vdmc_transform_lod_delta_qp[ index ][ ltpIndex ][ i ][ j ] | |
| if ( vdmc_transform_lod_delta_qp[ index ][ ltpIndex ][ i ][ j ] ) | |
| vdmc_transform_lod_delta_qp_sign[ index ][ ltpIndex ][ i ][ j ] | u(1) |
| } | |
| } | |
| } | |
| } | |

To encode the displacements component using existing video encoding standards, the transformed displacement components are mapped from a one-dimensional array to a 2-dimensional image.

Each unit vector component is associated with a different colour plane.

One example is when the Normal unit vector is mapped to Y-plane; the Tangent unit vector is mapped to U-plane; the BiTangent unit vector is mapped to V-plane. In this case, YUV444 colour mapping is used for encoding.

The drawback of such an approach is that any update of the QP parameter requires signaling an entire vdmc_lifting_transform_parameters (index, ltpIndex) structure in a corresponding header syntax element.

TABLE 2
Syntax elements On a sequence level

| | Descriptor |
|---|---|
| asps_vdmc_extension( ) { | |
| asps_vdmc_ext_subdivision_method | u(3) |
| if(asps_vdmc_ext_subdivision_method != 0) | |
| asps_vdmc_ext_subdivision_iteration_count | u(8) |
| asps_vdmc_ext_displacement_coordinate_system | u(1) |
| asps_vdmc_ext_transform_method | u(3) |
| if(asps_vdmc_ext_transform_method == LINEAR_LIFTING) { | |
| vdmc_lifting_transform_parameters( 0, 0 ) | |
| } | |
| asps_vdmc_ext_num_attribute_video | u(7) |
| for(i=0; i< asps_vdmc_ext_num_attribute_video; i++){ | |
| asps_vdmc_ext_attribute_type_id[ i ] | u(8) |
| asps_vdmc_ext_attribute_frame_width[ i ] | ue(v) |
| asps_vdmc_ext_attribute_frame_height[ i ] | ue(v) |
| asps_vdmc_ext_attribute_transform_method[ i ] | u(3) |
| if(asps_vdmc_ext_attribute_transform_method == | |
| LINEAR_LIFTING ) { | |
| vdmc_lifting_transform_parameters(i + 1, 0) | |
| asps_vdmc_ext_direct_attribute_projection_enabled_flag[ i ] | u(1) |
| } | |
| asps_vdmc_ext_packing_method | u(1) |
| asps_vdmc_ext_1d_displacement_flag | u(1) |
| asps_vdmc_ext_projection_textcoord_enable_flag | u(1) |
| if( asps_vdmc_ext_projection_textcoord_enable_flag ){ | |
| asps_vdmc_ext_projection_textcoord_mapping_method | u(2) |
| asps_vdmc_ext_projection_textcoord_scale_factor | fl(64) |
| } | |
| asps_vdmc_ext_displacement_qp_minus_N | u(6) |
| } | |

TABLE 3
Syntax elements on a frame level

| | Descriptor |
|---|---|
| afps_vdmc_extension( ) { | |
| afps_vdmc_ext_overriden_flag | u(1) |
| if(afps_vdmc_ext_overriden_flag){ | |
| afps_vdmc_ext_subdivision_enable_flag | u(1) |
| afps_vdmc_ext_displacement_coordinate_system_enable_flag | u(1) |
| afps_vdmc_ext_transform_method_enable_flag | u(1) |
| afps_vdmc_ext_transform_parameters_enable_flag | u(1) |
| afps_vdmc_ext_attribute_parameters_overwrite_flag | u(1) |
| } | |
| if(afps_vdmc_ext_subdivision_enable_flag){ | |
| afps_vdmc_ext_subdivision_method | u(3) |
| if(afps_vdmc_ext_subdivision_method!=0) | |
| afps_vdmc_ext_subdivision_iteration_count | u(8) |
| } | |
| if(afps_vdmc_ext_displacement_coordinate_system_enable_flag) | |
| afps_vdmc_ext_displacement_coordinate_system | u(1) |
| if(afps_vdmc_ext_transform_method_enable_flag) | |
| afps_vdmc_ext_transform_method | u(3) |
| if(afps_vdmc_ext_transform_method == LINEAR_LIFTING && | |
| afps_vdmc_ext_transform_parameters_enable_flag) | |
| vdmc_lifting_transform_parameters( 0, 1 ) | |
| afps_vdmc_ext_3d_offset_enable_flag | u(1) |
| if(afps_vdmc_ext_attribute_parameters_overwrite_flag){ | |
| for(i=0; i< asps_vdmc_ext_num_attribute_video; i++){ | |
| afps_vdmc_ext_attribute_transform_method_enable_flag[ i ] | u(1) |
| afps_vdmc_ext_attribute_transform_parameters_enable_flag[ i ] | u(1) |
| if(afps_vdmc_ext_attribute_transform_method_enable_flag[ i ]) | |
| afps_vdmc_ext_attribute_transform_method[ i ] | u(3) |
| if(afps_vdmc_ext_attribute_transform_method == | |
| LINEAR_LIFTING && | |
| afps_vdmc_ext_attribute_transform_parameters_enable_flag) | |
| vdmc_lifting_transform_parameters( i+ 1, 1 ) | |
| } | |
| } | |
| afps_vdmc_ext_single_attribute_tile_in_frame_flag | u(1) |
| if(!afps_vdmc_ext_single_attribute_tile_in_frame_flag) | |
| afps_ext_vdmc_attribute_tile_information( ) | |
| afps_ext_vdmc_mesh_information( ) | |
| if( asps_vdmc_ext_projection_textcoord_enable_flag ){ | |
| for( i = 0;i < NumSubMeshes; i++ ){. | |
| afps_vdmc_ext_projection_textcoord_present_flag[ i ] | u(1) |
| if(afps_vdmc_ext_projection_textcoord_present_flag){ | |
| afps_vdmc_ext_projection_textcoord_width[ i ] | ue(v) |
| afps_vdmc_ext_projection_textcoord_height[ i ] | ue(v) |
| afps_vdmc_ext_projection_textcoord_gutter[ i ] | ue(v) |
| } | |
| } | |
| } | |
| } | |

TABLE 4
Syntax elements on a patch level

| | Descriptor |
|---|---|
| patch_data_unit( tileID, patchIdx ) { | |
| pdu_submesh_id[ tileID ][ patchIdx ] | u(v) |
| pdu_vertex_count_minus1[ tileID ][ patchIdx ] | ue(v) |
| pdu_face_count_minus1[ tileID ][ patchIdx ] | ue(v) |
| pdu_2d_pos_x[ tileID ][ patchIdx ] | ue(v) |
| pdu_2d_pos_y[ tileID ][ patchIdx ] | ue(v) |
| pdu_2d_size_x_minus1[ tileID ][ patchIdx ] | ue(v) |
| pdu_2d_size_y_minus1[ tileID ][ patchIdx ] | ue(v) |
| pdu_parameters_enable_flag[ tileID ][ patchIdx ] | u(1) |
| if(pdu_parameters_enable_flag){ | |
| pdu_subdivision_enable_flag[ tileID ][ patchIdx ] | u(1) |
| pdu_displacement_coordinate_system_enable_flag[ tileID ] | u(1) |
| [ patchIdx ] | |
| pdu_transform_method_enable_flag[ tileID ][ patchIdx ] | u(1) |
| pdu_transform_parameters_enable_flag[ tileID ][ patchIdx ] | u(1) |
| } | |
| if(pdu_subdivision_enable_flag[ tileID ][ patchIdx ]){ | |
| pdu_subdivision_method[ tileID ][ patchIdx ] | u(3) |
| if(pdu_subdivision_method[ tileID ][ patchIdx ]!=0) | |
| pdu_subdivision_iteration_count[ tileID ][ patchIdx ] | u(8) |
| } | |
| if(pdu_displacement_coordinate_system_enable_flag[ tileID ][ patchIdx ]) | |
| pdu_displacement_coordinate_system[ tileID ][ patchIdx ] | u(1) |
| if(pdu_transform_method_enable_flag[ tileID ][ patchIdx ]) | |
| pdu_transform_method[ tileID ][ patchIdx ] | u(3) |
| if(pdu_transform_method[ tileID ][ patchIdx ] == LINEAR_LIFTING && | |
| pdu_transform_parameters_enable_flag[ tileID ][ patchIdx ]) | |
| vdmc_lifting_transform_parameters(0, 2) | |
| for(i=0; i< asps_vdmc_ext_num_attribute_video; i++){ | |
| if(asps_vdmc_ext_direct_attribute_projection_enabled_flag[ i ]){ | |
| pdu_attributes_2d_pos_x[ tileID ][ patchIdx ][ i ] | ue(v) |
| pdu_attributes_2d_pos_y[ tileID ][ patchIdx ][ i ] | ue(v) |
| pdu_attributes_2d_size_x_minus1[ tileID ][ patchIdx ][ i ] | ue(v) |
| pdu_attributes_2d_size_y_minus1[ tileID ][ patchIdx ][ i ] | ue(v) |
| } | |
| } | |
| if( afps_vdmc_ext_projection_texcoord_present_flag[ smIdx ]){ | |
| pdu_faceID_to_subpatchIdx_identity_mapping_flag[ tileID ][ patchIdx ] | u(1) |
| pdu_projection_texcoord_frame_scale[ tileID ][ patchIdx ] | fl(64) |
| pdu_projection_texcoord_faceID_count_minus1[ tileID ] | ue(v) |
| [ patchIdx ] | |
| numSubPatches = pdu_projection_texcoord_faceID_count_minus1[ tileID ][ p | |
| atchIdx ] + 1 | |
| for( i = 0; i < numSubPatches; i++){ | |
| if( !pdu_faceID_to_subpatchIdx_identify_flag[ tileID ][ patchIdx ] ) | |
| pdu_faceID_to_subpatchIdx[ tileID ][ patchIdx ][ i ] | ue(v) |
| pdu_projection_texcoord_projection_id[ tileID ][ patchIdx ][ i ] | u(v) |
| pdu_projection_texcoord_orientation_id[ tileID ][ patchIdx ][ i ] | u(2) |
| pdu_projection_texcoord_2d_pos_x[ tileID ][ patchIdx ][ i ] | ue(v) |
| pdu_projection_texcoord_2d_pos_y[ tileID ][ patchIdx ][ i ] | ue(v) |
| pdu_projection_texcoord_2d_size_x_minus1[ tileID ][ patchIdx ][ i ] | ue(v) |
| pdu_projection_texcoord_2d_size_y_minus1[ tileID ][ patchIdx ][ i ] | ue(v) |
| pdu_projection_texcoord_scale_present_flag[ tileID ][ patchIdx ][ i ] | u(1) |
| if( pdu_projection_texcoord_scale_present_flag[ tileID ][ patchIdx ][ i ] ) | |
| pdu_projection_texcoord_subpatch_scale_power_factor[ tileID ][ patchId | ue(v) |
| x ][ i ] | |
| } | |
| } | |

It can be seen that any update of QPs needs to signal the complete structure of the vdmc_lifting_transform_parameters(index, ltpIndex) in the corresponding header syntax elements, which leads to high signaling overhead. Based on this, the embodiment of the present disclosure provides an encoding method and a decoding method. By signaling the difference of QPs between different levels, the corresponding delta QP (i.e, an increment of the QP) is encoded when there is a difference. Compared with explicitly signaling the delta QP of each level, the signaling overhead can be reduced, the encoding efficiency of displacement components can be improved, and the code rate can be reduced.

In order to facilitate understanding of the technical solutions of the embodiments of the present disclosure, the technical solutions of the present disclosure will be described in detail below by way of specific embodiments. As an optional solution, the above related technology can be randomly combined with the technical solution of the embodiment of the present disclosure, and all of them belong to the protection scope of the embodiment of the present disclosure. Embodiments of the present disclosure include at least some of the following.

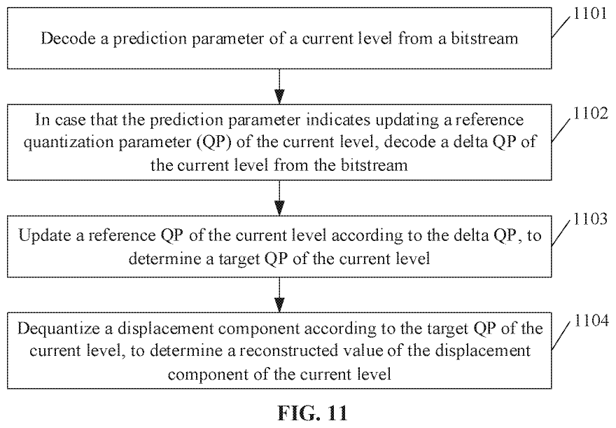

Embodiments of the present disclosure provide a decoding method. FIG. 11 illustrates a flowchart of a decoding method according to the embodiment of the present disclosure. As illustrated in FIG. 11, in the embodiment of the present disclosure, the decoding method performed by a decoder may include the following operations as illustrated in blocks. The method starts from block 1101.

At block 1101, a prediction parameter of a current level is decoded from a bitstream.

It should be noted that the dynamic mesh decoding process includes the following operations. A decoder decodes a base mesh bitstream, to obtain a decoded base mesh. The base mesh is subdivided by using a certain subdivision algorithm to obtain a subdivided mesh. For example, the base mesh is subdivided through two iterations, to obtain a subdivided mesh, where the base mesh is regarded as level 0 corresponding to the 0-th iteration, and vertices newly added during the first iteration form level 1, and vertices newly added during the second iteration form level 2. The geometry displacement bitstream is decoded by using a standard video encoder to obtain a two-dimensional (2D) image, and the 2D image is mapped from a 2D region to a three-dimensional space (or called “image unpacking”) to obtain quantization coefficients. Dequantization and inverse transform are applied to quantization coefficients, to obtain reconstructed values of displacements. Geometry information of a reconstructed 3D mesh is generated based on the subdivided mesh and displacements.

The decoding method according to the embodiment of the present disclosure may be a decoding method for a dynamic mesh, and more specifically, the decoding method may be a method for decoding geometry displacement components of the dynamic mesh.

Displacement refer to difference between the original mesh geometry and the subdivided mesh geometry. The displacement includes displacement components in one or more directions, as illustrated in FIG. 9. The displacement may include a displacement component in a normal direction, a displacement component in a tangent direction, and a displacement component in a bitangent direction.

In image decoding, parameters are often defined and adjusted on different levels (such as sequence level, frame level and patch level). The parameters of these levels are interrelated and can be derived according to the correlation between the parameters. In embodiments of the present disclosure, the current level may be a parameter level, for example, the current level may include at least one of the following: sequence level, LoD level, frame level, patch level, or the like. More specifically, the current level may be a parameter level of the current displacement component to be decoded, and the current displacement component to be decoded may be any one of the displacement components.

The prediction parameter indicates whether to update a reference QP of the current level, that is, the prediction parameter indicates whether a target QP of the current level is different from the reference QP of the current level. If there is a difference, then a delta QP (i.e., an increment of the QP) of the current level is decoded. If there is no difference, the delta QP does not need to be decoded, thus reducing the signaling overhead in decoding the QP.

In some possible implementations, the prediction parameter may include a first syntax element indicating whether to update the reference QP of the current level.

Exemplarily, the first syntax element includes at least one of the following: a sequence-level first syntax element, a Level-of-Details (LoD) first syntax element, a frame-level first syntax element, or a patch-level first syntax element. That is, when the current level is a current sequence, the sequence-level first syntax element is used to indicate whether to update the reference QP of the current sequence. When the current level is a current LoD, the LoD first syntax element is used to indicate whether to update the reference QP of the current LoD. When the current level is a current frame, the frame-level first syntax element is used to indicate whether to update the reference QP of the current frame. When the current level is a current patch, the patch-level first syntax element is used to indicate whether to update the reference QP of the current patch.

Exemplarily, the current level may further include other levels, and the first syntax element may include other level first syntax elements.

In some possible implementations, when the value of the first syntax element is a first value, it is determined not to update the reference QP of the current level. When the value of the first syntax element is a second value, it is determined to update the reference QP of the current level. When not present, the value of the first syntax element is inferred as a first value. Exemplarily, the first value may be 0 and the second value may be 1.

In some possible implementations, the prediction parameter may further include a second syntax element indicating whether to use a first transform mode for performing displacement component transform on the current level. The first transform mode may be lifting wavelet transform.

Exemplarily, the method may further include the following operations. In case that the first syntax element indicates updating the reference QP of the current level, and/or the second syntax element indicates using the first transform mode for performing displacement component transform on the current level, it is determined to update the reference QP of the current level. In case that the first syntax element indicates not updating the reference QP of the current level, or the second syntax element indicates not using the first transform mode for performing displacement component transform on the current level, it is determined not to update the reference QP of the current level.

That is, whether to update the reference QP of the current level can be determined according to the value of the first syntax element and/or the value of the second syntax element. The first transform mode includes quantizing the displacement component, and the transform parameters corresponding to the first transform mode include a QP. If the first transform mode is determined to be used, it is further determined whether to update the reference QP of the current level according to the first syntax element, and if the first transform mode is determined not to be used, it is determined not to update the reference QP of the current level.

In some possible implementations, the first syntax element includes at least one of the following: a LoD first syntax element, a frame-level first syntax element, or a patch-level first syntax element. The second syntax element includes at least one of the following: a sequence-level second syntax element, or a frame-level second syntax element.

Exemplarily, when the current level is a current sequence, a sequence-level second syntax element is used to indicate whether to update the reference QP of the current level. When the current level is a current LoD, an LoD first syntax element is used to indicate whether to update the reference QP of the current level. When the current level is a current frame, a frame-level first syntax element and a frame-level second syntax element are used to indicate whether to update the reference QP of the current frame. When the current level is a current patch, a patch-level first syntax element is used to indicate the reference QP of the current patch.

In some possible implementations, the prediction parameter may further include a third syntax element indicating a number of attributes. The operation of decoding the delta QP of the current level from the bitstream includes: decoding the delta QP for each of one or more attributes of the current level from the bitstream according to the number of attributes.

It should be noted that each of the attributes has a corresponding related parameter, and the attributes can be color, reflectance, transparency and so on. In the embodiment of the present disclosure, the delta QP for each of one or more attributes is decoded according to the number of attributes, thereby determining one or more QPs for the one or more attributes. When decoding a displacement component, a corresponding QP can be selected according to a vertex attribute.

In some possible implementations, the prediction parameter may further include a fourth syntax element indicating that different QPs are used for different attributes of the current level. The operation of decoding the delta QP for each of one or more attributes of the current level from the bitstream includes: decoding the delta QP for each of the one or more attributes of the current level from the bitstream according to the number of attributes, in case of determining that different QPs are used for different attributes of the current level.

In some possible implementations, when the value of the fourth syntax element is a first value, it is determined that the same QP is used for different attributes. When the value of the fourth syntax element is a second value, it is determined that different QPs are used for different attributes.

In some possible implementations, the third syntax element may be a sequence-level syntax element indicating the number of attributes of the current sequence. The fourth syntax element may be a frame-level syntax element indicating whether to use different QPs for different attributes of the current frame.

At block 1102, a delta QP of the current level is decoded from the bitstream, in case that the prediction parameter indicates updating a reference QP of the current level.

The delta QP is a variation of the reference QP, which is used to adjust the reference QP, so as to obtain a target reference QP used by the current level. In some possible implementations, the delta QP includes an absolute value of the delta QP and a sign of the delta QP, where the absolute value of the delta QP can also be called a difference modulus, which is used to indicate the size of the difference, and can be a non-zero value, and the sign of the delta QP indicates whether the difference is positive or negative. In the embodiment of the present disclosure, the absolute value of the delta QP may be denoted as delta_QP, specifying the absolute value of the difference between the target QP and the reference QP of the current level, and the sign of the delta QP may be denoted as delta_QP_sign, specifying the sign of the difference between the target QP and the reference QP of the current level.

Exemplarily, the absolute value of the delta QP of the current level is decoded from the bitstream. When the absolute value of the delta QP is not zero, the sign of the delta QP of the current level is decoded from the bitstream. When not present, the absolute value of the delta QP is inferred to as 0.

At block 1103, the reference QP of the current level is updated according to the QP, to determine a target QP of the current level.

It should be noted that the reference QP is a QP which has correlation with the target QP.

In some possible implementations, the reference QP of the current level is determined based on a first QP, where the first QP is an initial QP, or a target QP of a reference level of the current level. The initial QP may be a global parameter, and the reference level may be one or more decoded levels that have parameter correlation with the current level.

For example, the first QP is used as a reference QP of the current level; or the first QP is converted to a reference QP based on a preset mapping relationship.

In some possible implementations, when the current level is a first level, the first QP is the initial QP. When the current level is a second level, the first QP is the target QP of the reference level of the current level.

That is, for the first level, the reference QP is determined by using a global parameter; and for the second level, the reference QP is determined by using the target QP of the reference level. The first level includes one or more levels, for example, the first level is current sequence. The second level includes one or more levels, for example, the second level includes at least one of the following: current LoD, current frame, or current patch.

In some possible implementations, the reference level is a decoded adjacent level of the current level. Exemplarily, the reference level of the current LoD is the current sequence; the reference level of the current frame is the current LoD; and the reference level of the current patch is the current frame.

In some embodiments, the method may further include the operations of decoding a reference value of the QP from the bitstream, and determining the initial QP based on the reference value of the QP and a default value of the QP.

The reference value of the QP is signaled in the bitstream. When the initial QP needs to be updated, it only needs to signal the updated reference value of the QP, which saves signaling overhead compared with updating the initial QP.

The default value of the QP is a pre-defined parameter, and the default value of the QP may be a middle value in a value range of the QP.

In some possible implementations, when the delta QP includes an absolute value of the delta QP and a sign of the delta QP, a true value of the delta QP is determined according to the absolute value of the delta QP and the sign of the delta QP; and a sum of the reference QP and the true value of the delta QP is calculated, to obtain the target QP. The calculation formula is as follows:

$$q {p}_{curIdx} = q {p}_{refIdx} + ( 1 - 2 * delta\_qp {\_sign}_{curIdx} ) * {delta\_qp}_{curIdx}$$

where qp_{curIdx} denotes the target QP of the current level, qp_{refIdx} denotes the reference QP of the current level, delta_qp_signcurldx denotes the sign of the delta QP, and the delta_qp_{curIdx} denotes the absolute value of the delta QP.

At block 1104, a displacement component is dequantized according to the target QP of the current level, to determine a reconstructed value of the displacement component of the current level.

In some possible implementations, the method may further include the following operations. The geometry displacement bitstream is decoded to obtain a two-dimensional (2D) image. The 2D image is mapped from a two-dimensional region to a three-dimensional space, to obtain quantization coefficients. Quantization coefficients of the current displacement components are dequantized according to the target QP of the current level, to obtain reconstructed values of the quantization coefficients. The reconstructed values of the transform coefficients are inversely transformed, to obtain the reconstructed values of the current displacement components.

In some possible implementations, when the current level is not a third level, a reference QP of the next level is determined according to the target QP of the current level. When the current level is the third level, displacement components are de-quantized according to the target QP of the current level, and reconstructed values of the displacement components of the current level are determined.

The third level is a quantization unit of the displacement components. If the current level is the third level, the displacement components are de-quantized. If the current level is not the third level, the target QP of the current level is taken as a reference QP of an adjacent level that has not been decoded.

Exemplarily, the third level may include at least one of the following: an LoD of a current frame, a current tile, a current patch, or the like.

In order to better embody the purpose of the present disclosure based on the above-mentioned embodiments of the present disclosure, further examples are given for the improved parts of the syntax elements of each level.

TABLE 5
Improvements of the sequence-level syntax elements

| | |
|---|---|
| asps_vdmc_extension( ) { | Descriptor |
| asps_vdmc_ext_subdivision_method | u(3) |
| if(asps_vdmc_ext_subdivision_method != 0) | |
| asps_vdmc_ext_subdivision_iteration_count | u(8) |
| asps_vdmc_ext_displacement_coordinate_system | u(1) |
| asps_vdmc_ext_transform_method | u(3) |
| asps_vdmc_ext_1d_displacement_flag | u(1) |
| if(asps_vdmc_ext_transform_method == LINEAR_LIFTING) { | |
| asps_vdmc_ext_displacement_qp_minus_N | se(v) |
| } | |
| asps_vdmc_ext_num_attribute_video | u(7) |
| for(i=0; i< asps_vdmc_ext_num_attribute_video; i++){ | |
| asps_vdmc_ext_attribute_type_id[ i ] | u(8) |
| asps_vdmc_ext_attribute_frame_width[ i ] | ue(v) |
| asps_vdmc_ext_attribute_frame_height[ i ] | ue(v) |
| asps_vdmc_ext_attribute_transform_method[ i ] | u(3) |
| if( asps_vdmc_ext_attribute_transform_method == LINEAR_LIFTING ) | |
| { | |
| for( j = 0; j < numDispComp; j++ ) { | |
| asps_delta_qp[ j ] | ue(v) |
| if ( vdmc_transform_lod_delta_qp[ j ] ) | |
| asps_delta_qp_sign[ j ] | u(1) |
| } | |
| if (asps_vdmc_ext_LoD_qp_update_flag) { | |
| for( i=0 ; i < afps_vdmc_ext_subdivision_iteration_count + 1; i++ ){ | |
| asps_lod_delta_qp[ i ] | ue(v) |
| if ( vdmc_transform_lod_delta_qp [ i ] ) | |
| asps_lod_delta_qp_sign[ i ] | u(1) |
| } | |
| } | |
| } | |
| } | |
| asps_vdmc_ext_projection_textcoord_enable_flag | u(1) |
| if( asps_vdmc_ext_projection_textcoord_enable_flag ){ | |
| asps_vdmc_ext_projection_textcoord_mapping_method | u(2) |
| asps_vdmc_ext_projection_textcoord_scale_factor | fl(64) |
| } | |
| } | |

The cells with bold border in the table are the improved part, where

asps_vdmc_ext_attribute_transform_method (corresponding to the second syntax element) indicates the attribute transform method.

asps_vdmc_ext_num_attribute_video (corresponding to the third syntax element) indicates the number of attributes.

numDispComp is an internal variable derived from the syntax element asps_vdmc_ext_1d_displacement_flag. When asps_vdmc_ext_1d_displacement_flag is equal to 0, the value of numDispComp is equal to 3, when asps_vdmc_ext_1d_displacement_flag is equal to 1, the value of numDispComp is equal to 1. numDispComp indicates the number of displacement components.

asps_vdmc_ext_displacement_QP_minus_N plus N specifies plus N specifies the initial value of QP. As an example, N may be set to be 49.

asps_delta_QP [j] specifies the absolute difference of QP used between the initial QP indicated by asps_vdmc_ext_displacement_qp_minus_N and current QP for j-th displacement component of the current sequence, where the current QP is the target QP of the j-th displacement component of the current sequence. When it is not present, it is inferred that the value of asps_delta_qp is equal to 0.

asps_delta_qp_sign [j] specifies the sign of the difference of QP used between initial QP indicated by asps_vdmc_ext_displacement_qp_minus_N and current QP for the j-th displacement component. When asps_delta_qp_sign is equal to 0, the value is positive, when asps_delta_qp_sign is equal to 1, the value is negative.

asps_vdmc_ext_LOD_QP_update_flag (corresponding to the LoD first syntax element) specifies whether delta QP is allowed in all LODs of the current sequence, that is, whether to update the reference QP of the current LoD. If asps_vdmc_ext_LoD_QP_update_flag is equal to 1, the QP value of each LoD can be modified. If asps_vdmc_ext_LoD_qp_update_flag is equal to 0, the initial value will be used for all LoDs in the current patch of the current tile of the current frame.

afps_vdmc_ext_subdivision_iteration_count plus 1 specifies the number of subdivisions on the LOD.

asps_lod_delta_qp[i] specifies the absolute difference of QP used between sequence-level QP and current QP for i-th LoD for all components. The current QP is the target QP of the i-th LoD of the current sequence. When it is not present, it is inferred that the value of asps_lod_delta_qp is equal to 0.

asps_lod_delta_qp_sign[i] specifies the sign of the difference of QP used between sequence-level QP and current QP for i-th LoD. When asps_lod_delta_qp_sign is equal to 0, the value is positive. When asps_lod_delta_qp_sign is equal to 1, the value is negative.

TABLE 6
Improvements of Frame-level Syntax Elements

| | Descriptor |
|---|---|
| afps_vdmc_extension ( ) { | |
| afps_vdmc_ext_overriden_flag | u (1) |
| if (afps_vdmc_ext_overriden_flag) { | |
| afps_vdmc_ext_subdivision_enable_flag | u (1) |
| afps_vdmc_ext_displacement_coordinate_system_enable_flag | u (1) |
| afps_vdmc_ext_transform_method_enable_flag | u (1) |
| [symbol] | [symbol] |
| afps_vdmc_ext_attribute_parameters_overwrite_flag | u (1) |
| afps_vdmc_ext_qp_update_flag | u (1) |
| } | |
| if (afps_vdmc_ext_subdivision_enable_flag) { | |
| afps_vdmc_ext_subdivision_method | u (3) |
| if (afps_vdmc_ext_subdivision_method! = 0) | |
| afps_vdmc_ext_subdivision_iteration_count | u (8) |
| } | |
| if (afps_vdmc_ext_displacement_coordinate_system_enable_flag) | |
| afps_vdmc_ext_displacement_coordinate_system | u (1) |
| if (afps_vdmc_ext_transform_method_enable_flag) | |
| afps_vdmc_ext_transform_method | u (3) |
| if (afps_vdmc_ext_transform_method = = | |
| LINEAR_LIFTING & & afps_vdmc_ext_qp_update_flag) { | |
| [symbol] | |
| afps_delta_qp | ue (v) |
| if (afps_delta_qp) | |
| afps_delta_qp_sign | u (1) |
| } | |
| afps_vdmc_ext_3d_offset_enable_flag | u (1) |
| if (afps_vdmc_ext_attribute_parameters_overwrite_flag) { | |
| for (i=0; i < asps_vdmc_ext_num_attribute_video; i + +) { | |
| afps_vdmc_ext_attribute_transform_method_enable_flag | u (1) |
| [i] | |
| afps_vdmc_ext_qp_update_flag [i] | u (1) |
| if (afps_vdmc_ext_attribute_transform_method_enable_flag | |
| [i]) | |
| afps_vdmc_ext_attribute_transform_method [i] | u (3) |
| if (afps_vdmc_ext_attribute_transform_method = = | |
| LINEAR_LIFTING & & | |
| afps_vdmc_ext_qp_update_flag [i]) { | |
| [symbol] | |
| afps_delta_qp [i] | ue (v) |
| if (vdmc_transform_frame_delta_qp [i]) | |
| afps_delta_qp_sign [i] | u (1) |
| } | |
| } | |
| } | |
| afps_vdmc_ext_single_attribute_tile_in_frame_flag | u (1) |
| if (! afps_vdmc_ext_single_attribute_tile_in_frame_flag) | |
| afps_ext_vdmc_attribute_tile_information ( ) | |
| afps_ext_vdmc_mesh_information ( ) | |
| if (asps_vdmc_ext_projection_textcoord_enable_flag) { | |
| for (i = 0; i < NumSubMeshes; i + +) {. | |
| afps_vdmc_ext_projection_textcoord_present_flag [i] | u (1) |
| if (afps_vdmc_ext_projection_textcoord_present_flag) { | |
| afps_vdmc_ext_projection_textcoord_width [i] | ue (v) |
| afps_vdmc_ext_projection_textcoord_height [i] | ue (v) |
| afps_vdmc_ext_projection_textcoord_gutter [i] | ue (v) |
| } | |
| } | |
| } | |
| } | |

afps_vdmc_ext_QP_update_flag specifies whether delta QP is allowed in the current displacement component frame i.e. whether to update the reference QP of the current frame. afps_vdmc_ext_qp_update_flag equal to 1 specifies that the delta QP is allowed. afps_vdmc_ext_qp_update_flag equal to 0 specifies that the delta QP is not allowed. When not present, the value of afps_vdmc_ext_qp_update_flag is inferred to be equal to a default value, which can be 0.

afps_delta_QP [i] specifies the absolute difference between the sequence level QP for each LoD and the current QP for the current frame, which is the target QP of each LoD of the current frame. When not present, the value of afps_delta_qp is inferred as 0.

afps_delta_QP_sign [i] specifies the sign of the difference between the sequence level QP for each LoD and the current QP for the current frame.

The afps_vdmc_ext_attribute_parameters_overwrite_flag (corresponding to the fourth syntax element) indicates whether different QPs are used for different attributes of the current frame.

TABLE 7
Improvements of patch level syntax elements

| | Descriptor |
|---|---|
| patch_data_unit (tileID, patchIdx) { | |
| pdu_submesh_id [tileID] [patchIdx] | u (v) |
| pdu_vertex_count_minus1 [tileID] [patchIdx] | ue (v) |
| pdu_face_count_minus1 [tileID] [patchIdx] | ue (v) |
| pdu_2d_pos_x [tileID] [patchIdx] | ue (v) |
| pdu_2d_pos_y [tileID] [patchIdx] | ue (v) |
| pdu_2d_size_x_minus1 [tileID] [patchIdx] | ue (v) |
| pdu_2d_size_y_minus1 [tileID] [patchIdx] | ue (v) |
| pdu_parameters_enable_flag [tileID] [patchIdx] | u (1) |
| if (pdu_parameters_enable_flag) { | |
| pdu_subdivision_enable_flag [tileID] [patchIdx] | u (1) |
| pdu_displacement_coordinate_system_enable_flag [tileID] | u (1) |
| [patchIdx] | |
| pdu_transform_method_enable_flag [tileID] [patchIdx] | u (1) |
| pdu_qp_update_flag [tileID] [patchIdx] | u (1) |
| } | |
| if (pdu_subdivision_enable_flag [tileID] [patchIdx]) { | |
| pdu_subdivision_method [tileID] [patchIdx] | u (3) |
| if (pdu_subdivision_method [tileID] [patchIdx]! = 0) | |
| pdu_subdivision_iteration_count [tileID] [patchIdx] | u (8) |
| } | |
| if (pdu_displacement_coordinate_system_enable_flag [tileID] [patchIdx]) | |
| pdu_displacement_coordinate_system [tileID] [patchIdx] | u (1) |
| if (pdu_transform_method_enable_flag [tileID] [patchIdx]) | |
| pdu_transform_method [tileID] [patchIdx] | u (3) |
| if (pdu_transform_method [tileID] [patchIdx] = = linear_living & & | |
| pdu_pq_update_flag [tileID] [patchIdx]) { | |
| [symbol] | |
| pdu_delta_qp [tileID] [patchIdx] | ue (v) |
| if (pdu_delta_qp [tileID] [patchIdx]) | |
| pdu_delta_qp_sign [tileID] [patchIdx] | u (1) |
| if (asps_vdmc_ext_direct_attribute_projection_enabled_flag [i]) { | |
| pdu_attributes_2d_pos_x [tileID] [patchIdx] [i] | ue (v) |
| pdu_attributes_2d_pos_y [tileID] [patchIdx] [i] | ue (v) |
| pdu_attributes_2d_size_x_minus1 [tileID] [patchIdx] [i] | ue (v) |
| pdu_attributes_2d_size_y_minus1 [tileID] [patchIdx] [i] | ue (v) |
| } | |
| } | |
| if (afps_vdmc_ext_projection_texcoord_present_flag [smIdx]) { | |
| pdu_faceID_to_subpatchIdx_identity_mapping_flag [tileID] | u (1) |
| [patchIdx] | |
| pdu_projection_texcoord_frame_scale [tileID] [patchIdx] | fl (64) |
| pdu_projection_texcoord_faceID_count_minus1 [tileID] [patchIdx] | ue (v) |
| numSubPatches = pdu_projection_texcoord_faceID_count_minus1 | |
| [tileID] [patchIdx] + 1 | |
| for (i = 0; i < numSubPatches; i + +) { | |
| if (! Pdu_faceID_to_subpatchIdx_identifi_flag [tileID] | |
| [patchIdx]) | |
| pdu_faceID_to_subpatchIdx [tileID] [patchIdx] [i] | ue (v) |
| pdu_projection_texcoord_projection_id [tileID] [patchIdx] | u (v) |
| [i] | |
| pdu_projection_texcoord_orientation_id [tileID] [patchIdx] | u (2) |
| [i] | |
| pdu_projection_texcoord_2d_pos_x [tileID] [patchIdx] [i] | ue (v) |
| pdu_projection_texcoord_2d_pos_y [tileID] [patchIdx] [i] | ue (v) |
| pdu_projection_texcoord_2d_size_x_minus1 [tileID] | ue (v) |
| [patchIdx] [i] | |
| pdu_projection_texcoord_2d_size_y_minus1 [tileID] | ue (v) |
| [patchIdx] [i] | |
| pdu_projection_texcoord_scale_present_flag [tileID] | u (1) |
| [patchIdx] [i] | |
| if (pdu_projection_texcoord_scale_present_flag [tileID] | |
| [patchIdx] [i]) | |
| pdu_projection_texcoord_subpatch_scale_power_factor [tileID] [patchIdx] | ue (v) |
| [i] | |
| } | |
| } | |

pdu_qp_update_flag[tileID][patchIdx] specifies whether delta QP is allowed in the current displacement component patch with patchIdx of the tile with tileID, i.e., whether to update the reference QP of the current patch. pdu_qp_update_flag equal to 1 specifies that the delta QP is allowed. pdu_qp_update_flag equal to 0 specifies that the delta QP is not allowed. When not present, the value of pdu_qp_update_flag is inferred to be equal to 0.

pdu_delta_qp[tileID] [patchIdx] specifies the absolute difference between the frame level QP for each LoD and the current QP for the current patch, where the current QP is the target QP for the current patch. When not present, the value of pdu_delta_qp is inferred as 0.

pdu_delta_qp_sign[tileID] [patchIdx] specifies the sign of the difference between the frame level QP for each LoD and the current QP for the current patch with patchIdx within tile with TileID. When not present, the value of pdu_delta_qp is inferred as 0.

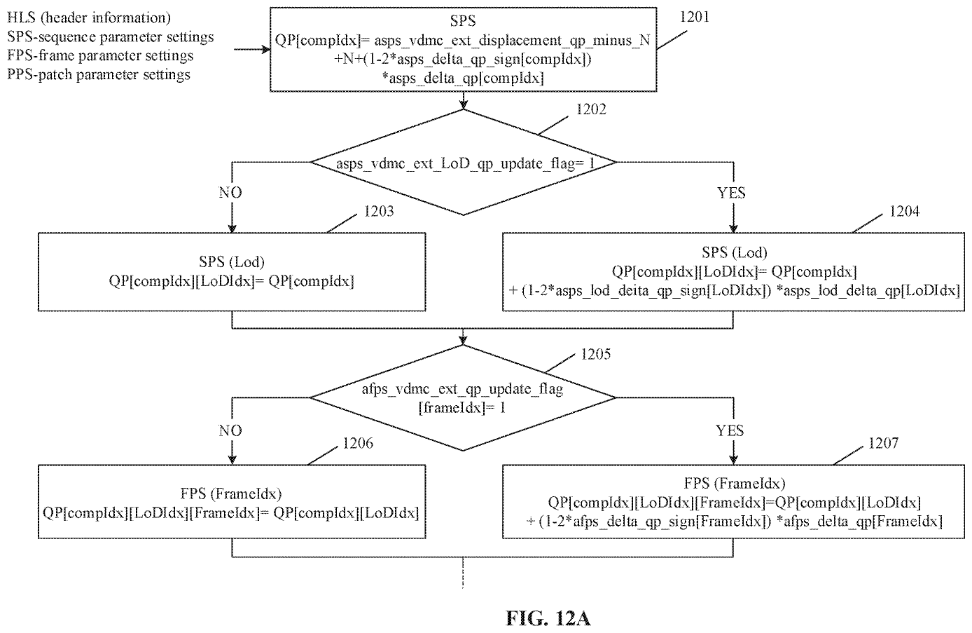

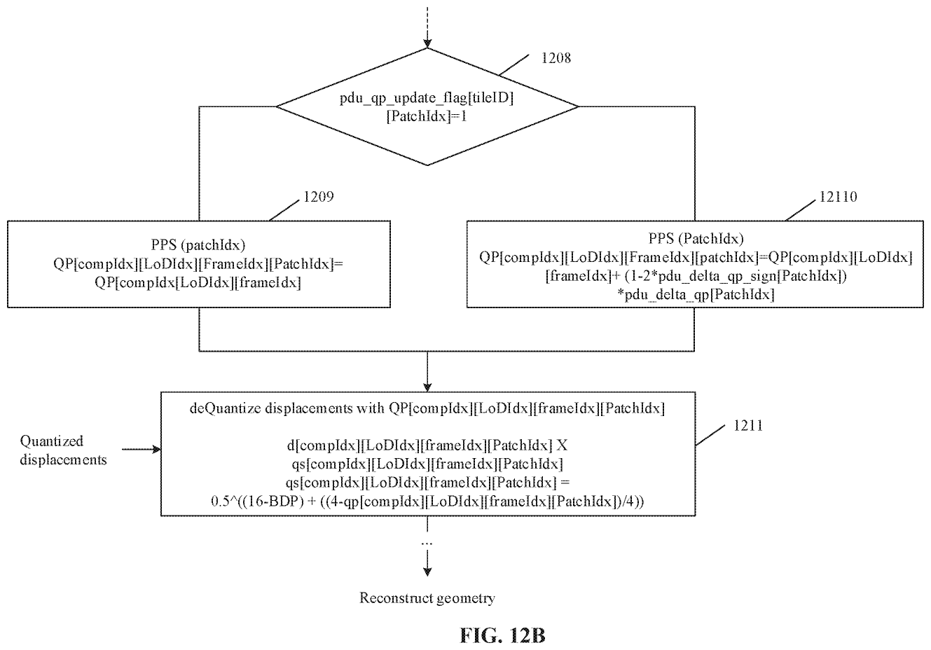

Further, the process for decoding displacement components is further illustrated. FIGS. 12A and 12B illustrates a flowchart of dequantization of a displacement component in an embodiment of the present disclosure. As illustrated in FIG. 12S. 12A and 12B, the method for decoding a displacement component may include the following operations illustrated in blocks. The method starts from block 1201.

At block 1201, a target QP of the current sequence is determined according to the initial QP.

Specifically, the target QP of each displacement component of the current sequence is derived as follows:

$$QP [ compIdx ] = asps\_vdmc \_ext \_displacement \_qp \_minus \_N + N + ( 1 - 2 * asps\_delta \_qp \_sign [ compIdx ] ) * asps\_delta \_qp [ compIdx ] ,$$

where compIdx is a displacement component identifier, QP [compIdx] represents the target QP of a certain displacement component of the current sequence.

At block 1202, it is determined whether to update a reference QP of a current LoD. If no, an operation illustrated in block 1203 is performed. If yes, an operation illustrated in block 1204 is performed.

Specifically, it is determined to update the reference QP of the current LoD when the value of LoD first syntax element asps_vdmc_ext_LoD_qp_update_flag is 1, and it is determined not to update the reference QP of the current LoD when the value of LoD first syntax element asps_vdmc_ext_LoD_qp_update_flag is 0.

At block 1203, a target QP of the current LoD is determined according to the target QP of the current sequence.

Specifically, when the current LoD is not updated, the target QP of each displacement component of the current sequence is taken as the target QP of each displacement component of the current LoD, i.e. QP [compIdx][LoDIdx]=QP [compIdx], where compIdx is the displacement component identifier and LoDIdx is the LoD identifier.

At block 1204, a delta QP is decoded, and the target QP of the current LoD is determined according to the delta QP and the target QP of the current sequence.

Specifically, when the current LoD is updated, the process of deriving the target QP of each displacement component of the current LoD is as follows:

$$QP [ compIdx ] [ LoDIdx ] = QP [ compIdx ] + ( 1 - 2 * asps\_lod \_deita \_qp \_sign [ LoDIdx ] ) * asps\_lod \_delta \_qp [ LoDIdx ]$$

At block 1205, it is determined whether to update a reference QP of the current frame. If no, an operation illustrated in block 1206 is performed. If yes, an operation illustrated in block 1207 is performed.

Specifically, it is determined to update the reference QP of the current frame when the value of the first frame-level syntax element afps_vdmc_ext_qp_update_flag [FrameIdx] is 1, and it is determined not to update the reference QP of the current frame when the value of the first frame-level syntax element afps_vdmc_ext_qp_update_flag [FrameIdx] is 0.

At block 1206, a target QP of the current frame is determined according to the target QP of the current LoD.

Specifically, when the current frame is not updated, the target QP of each LoD of the current sequence is taken as the target QP of each LoD of the current frame, i.e. QP [compIdx] [LoDIdx] [frameIdx]=QP [compIdx] [LoDIdx], where compIdx is the displacement component identifier, LoDIdx is the LoD identifier, and frameIdx is the frame identifier.

At block 1207, the delta QP is decoded, and the target QP of the current frame is determined according to the delta QP and the target QP of the current LoD.

Specifically, when the current frame is updated, the process of deriving the target QP of the current frame is as follows:

$$QP [ compIdx ] [ LoDIdx ] [ FrameIdx ] = QP [ compIdx ] [ LoDIdx ] + ( 1 - 2 * afps\_delta \_qp \_sign [ FrameIdx ] ) * afps\_delta \_qp [ FrameIdx ]$$

At block 1208, it is determined whether to update a reference QP of the current patch. If no, an operation illustrated in block 1209 is performed; If yes, an operation illustrated in block 12010 is performed.

Specifically, it is determined to update the reference QP of the current patch when the value of the patch-level first syntax element pdu_qp_update_flag [tileID] [PatchIdx] is 1, and it is determined not to update the reference QP of the current patch when the value of the patch-level first syntax element pdu_qp_update_flag [tileID] [PatchIdx] is 0.

At block 1209, a target QP of the current patch is determined according to the target QP of the current frame.

Specifically, when the current patch is not updated, the target QP of the current frame is taken as the target QP of the current patch, i.e. QP [compIdx] [LoDIdx] [FrameIdx] [PatchIdx]=QP [compIdx [LoDIdx] [FrameIdx], where compIdx is the displacement component identifier, LoDIdx is the LoD identifier, FrameIdx is the frame identifier, and PatchIdx is the patch identifier.

At block 1210, the delta QP is decoded, and the target QP of the current patch is determined according to the delta QP and the target QP of the current frame.

Specifically, when the current patch is updated, the process of deriving the target QP of the current patch is as follows:

$$QP [ compIdx ] [ LoDIdx ] [ FrameIdx ] [ patchIdx ] = QP [ compIdx ] [ LoDIdx ] [ FrameIdx ] + ( 1 - 2 * pdu\_delta \_qp \_sign [ PatchIdx ] ) * pdu\_delta \_qp [ patchIdx ]$$

The final process of deriving the target QP of the current patch is as follows:

$$Q {P}_{c o m p I d {x}_{L o D I d {x}_{F r a m e I d {x}_{P a t c h I d x}}}} = asps\_vdmc \_ext \_displacement \_qp \_minus \_N + N + ( 1 - 2 * asps\_delta \_qp {\_sign}_{c ompIdx} ) * asps\_delta {\_qp}_{c ompIdx} + ( 1 - 2 * asps\_lod \_delta \_qp {\_sign}_{LoDIdx} ) * asps\_lod \_delta {\_qp}_{LoDIdx} + ( 1 - 2 * afps\_delta \_qp {\_sign}_{FrameIdx} ) * afps\_delta {\_qp}_{F r ameIdx} + ( 1 - 2 * pdu\_delta \_qp {\_sign}_{PatchIdx} ) * pdu\_delta {\_qp}_{PatchIdx}$$

At block 1211, Displacement wavelet coefficients of the current patch are de-quantized by using the target QP of the current patch.

$${d}_{c o m p I d {x}_{L o D I d {x}_{F r a m e I d {x}_{P a t c h I d x}}}} = d \times q {s}_{c o m p I d {x}_{L o D I d {x}_{F r a m e I d {x}_{P a t c h I d x}}}}$$

$$q {s}_{c o m p I d {x}_{L o D I d {x}_{F r a m e I d {x}_{P a t c h I d x}}}} = {( \frac{1}{2} )}^{16 - B P D + \frac{4 - Q {P}_{c o m p I d {x}_{L o D I d {x}_{F r a m e I d {x}_{P a t c h I d x}}}}}{6}}$$

where d is a displacement wavelet coefficient before dequantization, qs[compIdx][LoDIdx][frameIdx][PatchIdx] is a quantization step, d[compIdx][LoDIdx][frameldx][PatchIdx] is a displacement wavelet coefficient after dequantization, and BPD is a bit width depth.

The technical solution proposed in the present disclosure introduces effective and flexible signaling for the QPs of displacement components, reduces signaling overhead and improves decoding efficiency.

Further, the decoding process for the dynamic mesh is further illustrated, including the following five stages.

In a first stage, a base mesh is decoded from a geometry bitstream, and is recursively subdivided to LoDs defined by the encoder, to obtain a subdivided mesh.

At a second stage, a coded bitstream for geometry displacements is obtained and decoded with a codec the dmsps_mesh_codec_id, to obtain diplacements wavelet coefficients.

At a third stage, the displacement wavelet coefficients are dequantized using the QP signaled in the bitstream.

At a fourth stage, the dequantized displacement wavelet coefficients are processed with an inverse wavelet transform, to obtain reconstructed values of the displacement components.

At a fifth stage, mesh displacement components are applied to the subdivided base mesh at each transform level recursively to generate the reconstructed mesh consisting of blocks representing individual objects/regions of interest/volumetric tiles, semantic blocks, etc.

By adopting the technical solutions, the signaling overhead in signaling header information can be greatly reduced by modifying the QP signaling and derivation process. By signaling the difference of QPs between different levels, a corresponding delta QP is coded only when there is a difference. Compared with explicitly signaling the delta QP of each level, the signaling overhead can be reduced and the decoding efficiency can be improved. In addition, the QP default value can be defined at the global level to further reduce signaling overhead. The QP default value can be set to half of the QP range.

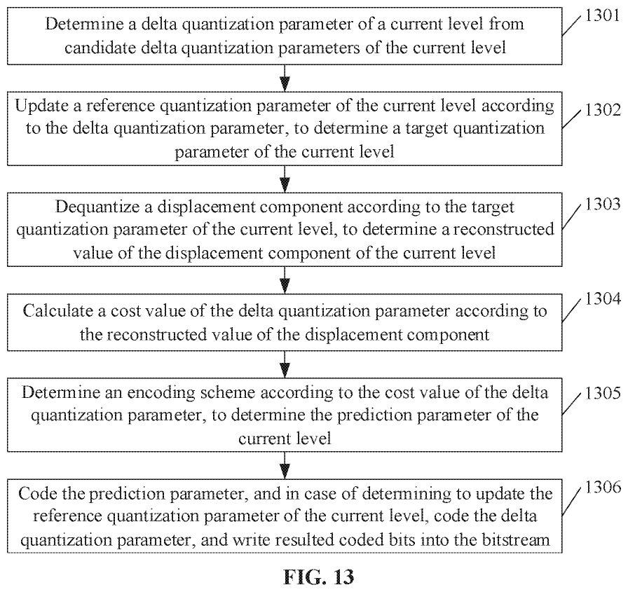

Based on the above embodiment, another embodiment of the present disclosure provides an encoding method. FIG. 13 illustrates a flowchart of the encoding method according to the embodiment of the present disclosure. As illustrated in FIG. 13, in the embodiment of the present disclosure, the encoding processing method applied to an encoder may include the following operations illustrated in blocks. The method may start from block 1301.

At block 1301, a delta QP of a current level is determined from candidate delta QPs of the current level.

It should be noted that the encoding method for the dynamic mesh includes the following operations. Down-sampling is performed on an original mesh to obtain a base mesh. The base mesh is subdivided by using a certain subdivision algorithm, to obtain a subdivided mesh. Finally, for each vertex in the subdivided mesh, a point in the original mesh closest to the vertex is found out, and a displacement between the two points is calculated. The base mesh and the displacements are coded.

The encoding method according to the embodiment of the present disclosure may be an encoding method for a dynamic mesh, and more particularly, the encoding method may be a method for encoding geometry displacement components in the dynamic mesh.

Displacement refer to difference between the original mesh geometry and the subdivided mesh geometry. A displacement may include displacement components in one or more directions, as illustrated in FIG. 9. A displacement may include a displacement component in a normal direction, a displacement component in a tangent direction, and a displacement component in a bitangent direction.

In image coding, parameters are often defined and adjusted at different levels (such as sequence level, frame level and patch level). The parameters of these levels are interrelated and can be derived according to the correlation between parameters. In embodiments of the present disclosure, the current level may be a parameter level, for example, the current level may include at least one of the following: sequence level, LoD level, frame level, patch level, or the like. More specifically, the current level is a parameter level of the current displacement component to be coded, and the current displacement component to be coded may be any displacement component.

The delta QP is a variation of the reference QP, which is used to adjust the reference QP, so as to obtain a target reference QP used by the current level. In some possible implementations, the delta QP includes an absolute value of the delta QP and a sign of the delta QP, where the absolute value of the delta QP can also be called a delta modulus, which is used to indicate the a size of delta QP, the absolute value of the delta QP can be a non-zero value, and the sign of the delta QP indicates whether the delta is positive or negative. In the embodiment of the present disclosure, the absolute value of the delta QP may be denoted as delta_QP, specifying the absolute difference between the target QP and the reference QP of the current level, and the sign of the delta QP may be denoted as delta_QP_sign, specifying the sign of the difference between the target QP and the reference QP of the current level.

In some possible implementations, the candidate delta QPs include one or more alternative non-zero delta QPs.

In some possible implementations, the candidate delta QPs further include a delta QP that is zero.

It should be noted that the candidate QPs corresponding to different levels are at least partially different, and the candidate QPs corresponding to different levels may also be the same.

At block 1302, a reference QP of the current level is updated according to the delta QP, to determine the target QP of the current level.

It should be noted that the reference QP is a QP which has correlation with the target QP.

In some possible implementations, the reference QP of the current level is determined based on a first QP, where the first QP is an initial QP, or a target QP of a reference level of the current level. The initial QP may be a global parameter, and the reference level may be one or more coded levels that have parameter correlation with the current level.

For example, the first QP is taken as the reference QP of the current level; or the first QP is converted to the reference QP based on a preset mapping relationship.

In some possible implementations, when the current level is a first level, the first QP is the initial QP. When the current level is a second level, the first QP is the target QP of the reference level of the current level.

That is, for the first level, the reference QP is determined by using a global parameter; and for the second level, the reference QP is determined by using the target QP of the reference level. The first level includes one or more levels, for example, the first level is a current sequence. The second level includes one or more levels, for example, the second level includes at least one of the following: a current LoD, a current frame, or a current patch.

In some possible implementations, the reference level is a decoded adjacent level of the current level. For example, the reference level of the current LoD is the current sequence; the reference level of the current frame is the current LoD; and the reference level of the current patch is the current frame.

In some embodiments, the method may further include the operation of determining a reference value of the QP based on the initial QP and a default value of the QP. The reference value of the QP is coded to obtain coded bits, which are written into the bitstream.

The reference value of the QP is signaled in the bitstream. When the initial QP needs to be updated, it only needs to signal the updated reference value of the QP, which saves signaling overhead compared with updating the initial QP.

The default value of the QP is a pre-defined parameter, which may be a middle value in the value range of the QP.

In some possible implementations, when the delta QP includes an absolute value of the delta QP and a sign of the delta QP, a true value of the delta QP is determined according to the absolute value of the delta QP and the sign of the delta QP; and a sum of the reference QP and the true value of the delta QP is calculated, to obtain the target QP. The calculation formula is as follows:

$$q {p}_{curIdx} = q {p}_{refIdx} + ( 1 - 2 * delta\_qp {\_sign}_{curIdx} ) * {delta\_qp}_{curIdx}$$

where qp_{curIdx} denotes the target QP of the current level, qp_{refIdx} denotes the reference QP of the current level, delta_qp_sign_{curIdx} denotes the sign of the delta QP, and the delta_qp_{curIdx} denotes the absolute value of the delta QP.

At block 1303, a displacement component is dequantized according to the target QP of the current level, to determine a reconstructed value of the displacement component of the current level.

In some possible implementations, the method further includes the following operations. Down-sampling is performed on an original mesh to obtain a base mesh. The base mesh is subdivided by using a certain subdivision algorithm, to obtain a subdivided mesh. Finally, for each vertex in the subdivided mesh, a point in the original mesh closest to the vertex is found out, and a displacement between the two points is calculated. The displacement includes displacement components in three directions. Transform and quantization are applied to each of the displacement components, to obtain reconstructed values of the transform coefficients. Inverse transform is applied to the reconstructed values of the transform coefficients, to obtain reconstructed values of the current displacement components.

In some possible implementations, when the current level is not a third level, a reference QP of the next level is determined according to the target QP of the current level. When the current level is the third level, the displacement component is dequantized according to the target QP of the current level, to determine a reconstructed value of the displacement component of the current level.

The third level is a quantization unit of the displacement component. If the current level is the third level, the displacement component is dequantized. If the current level is not the third level, the target QP of the current level is taken as the reference QP of the adjacent level that has not been coded.

Exemplarily, the third level may include at least one of the following: the LoD of the current frame, the current tile, the current patch, or the like.

At block 1304, a cost value of the delta QP is calculated according to the reconstructed value of the displacement component, by using, e.g., a cost function.

Exemplarily, the cost function may include at least one of: Rate-Distortion Optimization (RDO) Mean Square Error (MSE), Sum of Squared Difference (SSD), Sum of Absolute Difference (SAD), Sum of Absolute Transformed Difference (SATD), Peak Signal to Noise Ratio (PSNR), or the like.

At block 1305, an encoding scheme is determined according to the cost value of the delta QP, to determine the prediction parameter of the current level. The prediction parameter indicates whether to update the reference QP of the current level.

A minimum cost value is determined based on the cost value, and compared with the cost values in other encoding schemes, to determine whether to perform coding by using the encoding method according to the embodiment of the present disclosure, and the prediction parameter of the current level is configured based on determined encoding scheme.

In some possible implementations, the candidate delta QPs include a non-zero delta QP and a zero delta. The operation of determining the encoding scheme according to the cost value of the delta QP, to determine the prediction parameter of the current level, includes the following operations. When the delta QP corresponding to the minimum cost value is zero, it is determined that the prediction parameter indicates not updating the reference QP of the current level. When the delta QP corresponding to the minimum cost value is not zero, it is determined that the prediction parameter indicates updating the reference QP of the current level.

At block 1306, the prediction parameter is coded, and in case of determining to update the reference QP of the current level, the delta QP is coded, and the resulted coded bits are written into the bitstream.

The prediction parameter indicates whether to update the reference QP of the current level, that is, the prediction parameter indicates whether there is a difference between the target QP of the current level and the reference QP. If there is a difference, the delta QP of the current level is coded. If there is no difference, the delta QP is not coded, thus reducing the signaling overhead of the coded QP.

In some possible implementations, the prediction parameter may include a first syntax element indicating whether to update the reference QP of the current level.

Exemplarily, the first syntax element includes at least one of the following: a sequence-level first syntax element, a Level-of-Details (LoD) first syntax element, a frame-level first syntax element, or a patch-level first syntax element. That is, when the current level is a current sequence, the sequence-level first syntax element is used to indicate whether to update the reference QP of the current sequence. When the current level is a current LoD, the LoD first syntax element is used to indicate whether to update the reference QP of the current LoD. When the current level is a current frame, the frame-level first syntax element is used to indicate whether to update the reference QP of the current frame. When the current level is a current patch, the patch-level first syntax element is used to indicate whether to update the reference QP of the current patch.

Exemplarily, the current level may further include other levels, and the first syntax element may include other level first syntax elements.

In some possible implementations, when the value of the first syntax element is a first value, it is determined not to update the reference QP of the current level. When the value of the first syntax element is a second value, it is determined to update the reference QP of the current level. When not present, the value of the first syntax element is inferred as the first value. Exemplarily, the first value may be 0 and the second value may be 1.

In some possible implementations, the prediction parameter may further include a second syntax element indicating whether to use a first transform mode for performing displacement component transform on the current level. The first transform mode may be lifting wavelet transform.

Exemplarily, the method may further include the following operations. When it is determined, according to the determined encoding scheme, to update the reference QP of the current level, the first syntax element is used to indicate updating the reference QP of the current level, and/or the second syntax element is used to indicate using the first transform mode for performing displacement component transform on the current level. When it is determined, according to the determined encoding scheme, that no update of the reference QP of the current level is needed, the first syntax element is used to indicate not updating the reference QP of the current level, or the second syntax element is used to indicate not using the first transform mode for performing displacement component transform on the current level.

That is, whether to update the reference QP of the current level can be determined according to the value of the first syntax element and/or the value of the second syntax element. The first transform mode includes quantizing the displacement component, and the transform parameters corresponding to the first transform mode include a QP. If the first transform mode is determined to be used, it is further determined whether to update the reference QP of the current level according to the first syntax element, and if the first transform mode is determined not to be used, it is determined not to update the reference QP of the current level.

In some possible implementations, the first syntax element includes at least one of the following: a LoD first syntax element, a frame-level first syntax element, or a patch-level first syntax element. The second syntax element includes at least one of the following: a sequence-level second syntax element, or a frame-level second syntax element.

Exemplarily, when the current level is a current sequence, a sequence-level second syntax element is used to indicate whether to update the reference QP of the current level. When the current level is a current LoD, an LoD first syntax element is used to indicate whether to update the reference QP of the current level. When the current level is a current frame, a frame-level first syntax element and a frame-level second syntax element are used to indicate whether to update the reference QP of the current frame. When the current level is a current patch, a patch-level first syntax element is used to indicate the reference QP of the current patch.

In some possible implementations, the prediction parameter further includes a third syntax element indicating the number of attributes. The operation of coding the delta QP and writing the resulted coded bits into the bitstream includes coding the delta QP for each of one or more attributes of the current level according to the number of attributes and writing the resulted coded bits into the bitstream.

It should be noted that each of the attributes has a corresponding related parameter, and the attributes can be color, reflectance, transparency and so on. In the embodiment of the present disclosure, when coding a displacement component, a corresponding QP may be selected according to a vertex attribute, and the delta QP for each of one or more attributes may be coded.

In some possible implementations, the prediction parameter may further include a fourth syntax element indicating that different QPs are used for different attributes of the current level. The operation of coding the delta QP and writing the resulted coded bits into the bitstream includes: in case of determining that different QPs are used for different attributes of the current level, coding the delta QP for each of one or more attributes of the current level according to the number of attributes, and writing the resulted coded bits into the bitstream.

In some possible implementations, when the value of the fourth syntax element is a first value, it is determined that the same QP is used for different attributes. When the value of the fourth syntax element is a second value, it is determined that different QPs are used for different attributes.

In some possible implementations, the third syntax element may be a sequence-level syntax element indicating the number of attributes of the current sequence. The fourth syntax element may be a frame-level syntax element indicating whether to use different QPs for different attributes of the current frame.

In some possible implementations, the delta QP includes an absolute value of the delta QP and a sign of the delta QP. The operation of coding the delta QP includes the following operations. The absolute value of the delta is coded. When the absolute value of the delta QP is not zero, the sign of the delta QP is coded. When the absolute value of the delta is 0, the absolute value of the delta may not be coded.

On the encoding end, tables 5 to 7 show improvements of syntax elements on all levels.

The encoding process for the dynamic mesh is described as follows, including five stages.

In a first stage, mesh segmentation is performed, a step that creates segments or blocks of mesh content representing individual objects/regions of interest/volumetric tiles, semantic blocks, patches etc.

In a second stage, mesh decimation is performed to create a base mesh, and the base mesh is encoded with an undefined static mesh encoder. The base mesh is decoded and recursively subdivided to the number of level of details, to obtain a subdivided mesh. The number of level of details subdivisions is defined by asps_vmc_ext_subdivision_iteration_count.

In a third stage, mesh displacements are calculated between the subdivided mesh and the original surface for each level of details. The displacements are then processed with a wavelet transform.

In a fourth stage, wavelet transform coefficients are converted to a fix-point representation with a precision indicated in the coded bitstream at either patch, picture, or sequence level as signaled in the bitstream.

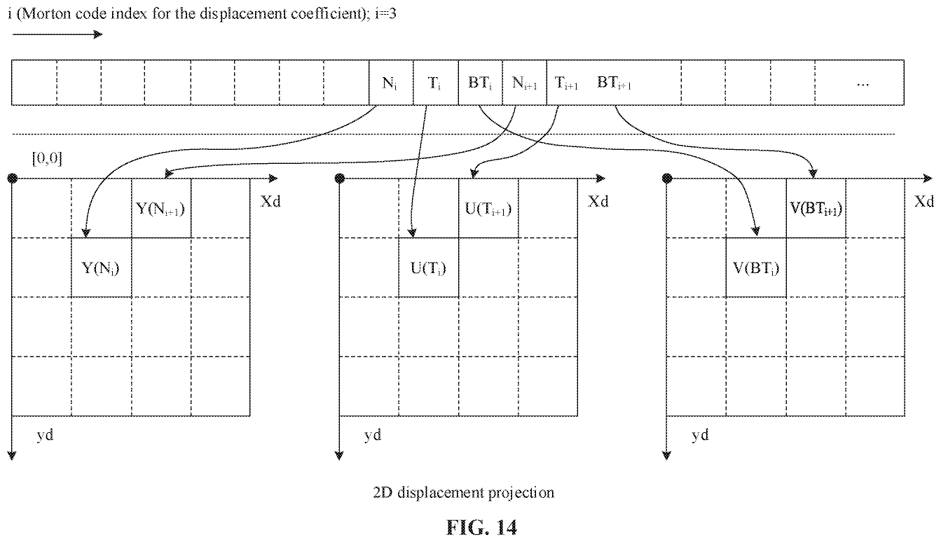

In a fifth stage, as illustrated in FIG. 14, the quantized wavelet coefficients are scanned along a 3D space scanning pattern (e.g., Morton, Hilbert, or along other space filling curve) within each LoD, forming three 1-dimensional arrays per each component. The coefficients are converted to a 2-dimensional image according to LoD and selected packing order. The unoccupied symbols in CTU are padded using one of the padding methods (e.g. zero-padding).

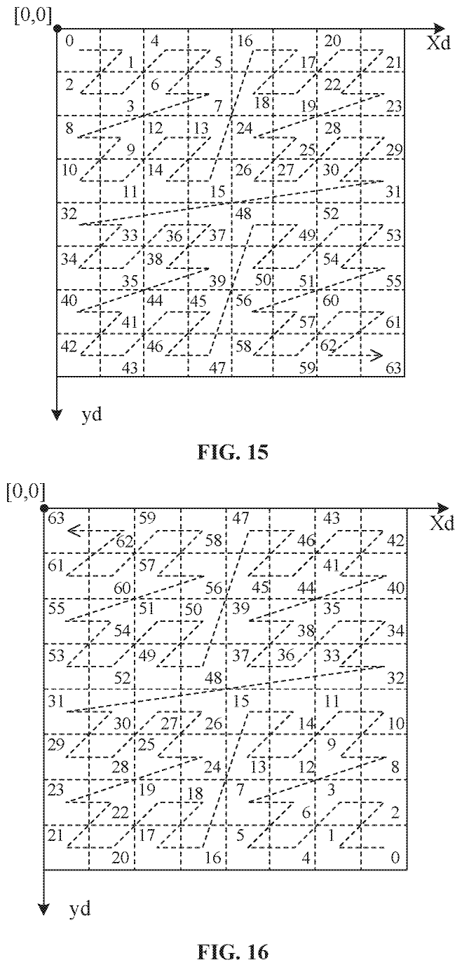

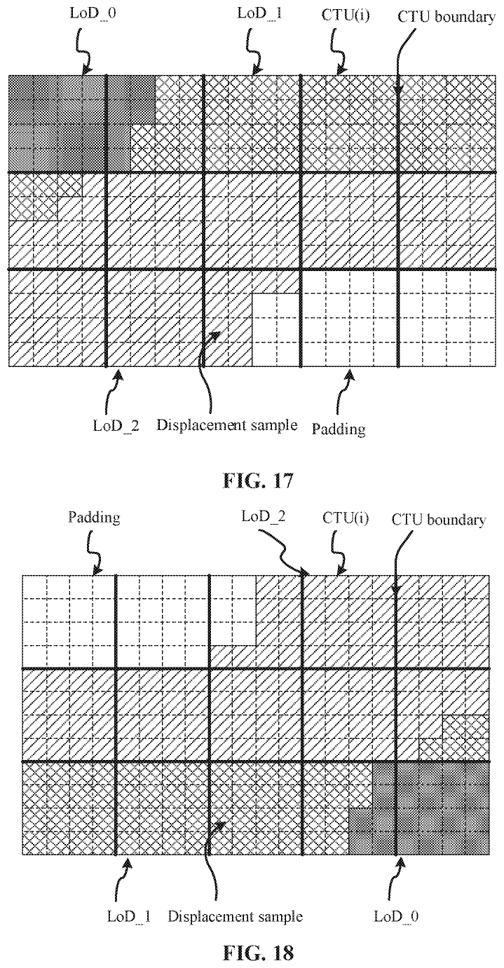

FIGS. 15 and 17 are diagrams illustrating LoD-based forward packing for displacement wavelet coefficients in the embodiment of the present disclosure. FIGS. 16 and 18 are diagrams illustrating LoD-based backward packing for displacement wavelet coefficients in the embodiment of the present disclosure.

By adopting the technical solutions described above, the signaling overhead in signaling header information can be greatly reduced by modifying the QP signaling and derivation process. Signaling the difference of QPs between different levels, and the corresponding delta QP is coded only when there is a difference. Compared with explicitly signaling the delta QP of each level, the signaling overhead can be reduced and the decoding efficiency can be improved. In addition, QP default values can be defined at the global level to further reduce signaling overhead. The QP default value can be set to half of the QP range.

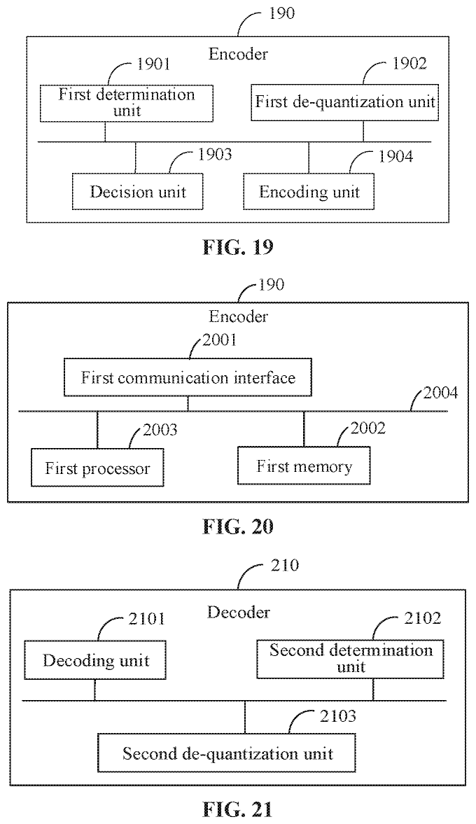

Based on the above-mentioned embodiments, in another embodiment of the present disclosure, based on the same inventive concept of the above-mentioned embodiments, FIG. 19 is a block diagram of a structure of an encoder. As illustrated in FIG. 19, the encoder 190 may include a first determination unit 1901, a first dequantization unit 1902, a decision unit 1903 and an encoding unit 1904.

The first determination unit 1901 is configured to determine a delta QP of a current level from candidate delta QPs of the current level, and update a reference QP of the current level according to the delta QP, so as to determine a target QP of the current level.

The first dequantization unit 1902 is configured to dequantize a displacement component according to the target QP of the current level, so as to determine a reconstructed value of the displacement component of the current level.

The decision unit 1903 is configured to calculate a cost value of the delta QP according to the reconstructed value of the displacement component, determine an encoding scheme according to the cost value of the delta QP, and determine a prediction parameter of the current level, where the prediction parameter indicates whether to update the reference QP of the current level.

The encoding unit 1904 is configured to code the prediction parameter, and in case of determining to update the reference QP of the current level, code the delta QP, and write resulted coded bits into the bitstream.

It will be understood that in this embodiment, a “unit” may be part of a circuit, part of a processor, part of a program or software, etc., Of course, it may also be a module, or it may be non-modular. Moreover, the components in the present embodiment may be integrated in one processing unit, or each unit may stand physically alone, or two or more units may be integrated in one unit. The integrated unit can be realized either in the form of hardware or in the form of software function modules.

The integrated unit, if implemented in the form of software functional modules and not sold or used as a stand-alone product, may be stored in a computer readable storage medium. Based on this understanding, the technical solutions of the present embodiment, in essence or in part contributing to the prior art, or in whole or in part of the technical solutions, may be embodied in the form of a software product stored in a storage medium, including instructions for causing a computer device (which may be a personal computer, server, or network device, etc.) or processor to perform all or in part of the steps of the method of the present embodiment. The aforementioned storage media includes a U disk, a removable hard disk, a Read Only Memory (ROM), a Random Access Memory (RAM), a magnetic disk or an optical disk and other media capable of storing program codes.

Thus, embodiments of the present disclosure provide a computer-readable storage medium applied to the encoder 220. The computer-readable storage medium stores a computer program that, when executed by a first processor, implements the encoding method of any of the preceding embodiments.

Based on the above-described composition of the encoder 220 and the computer-readable storage medium, as illustrated in FIG. 20, a schematic diagram of a specific hardware structure of the encoder 220 according to an embodiment of the present disclosure is provided. As illustrated in FIG. 20 the encoder 220 may include a first communication interface 2001 a first memory 2002 and a first processor 2003. Various components of the encoder 220 are coupled together by a first bus system 2004. It can be understood that the first bus system 2004 is configured to implement connection communication between these components. The first bus system 2004 includes a power bus, a control bus and a status signal bus, in addition to a data bus. However, for the sake of clarity, the various buses are designated as the first bus system 2004 in FIG. 20.

The first communication interface 2001 is configured to receive and transmit signals in a process of sending and receiving information with other external network elements.

The first memory 2002 is configured to store a computer program capable of running in the first processor 2003.

The first processor 2003 is configured to, when running a computer program, determine a delta QP of the current level from candidate delta QPs of the current level;

update a reference QP of the current level according to the delta QP, to determine the target QP of the current level;

dequantize a displacement component according to the target QP of the current level, to determine a reconstructed value of the displacement component of the current level;

calculate a cost value of the delta QP according to the reconstructed value of the displacement component;

determine an encoding scheme according to the cost value of the delta QP, to determine a prediction parameter of the current level, wherein the prediction parameter indicates whether to update the reference QP of the current level;

code the prediction parameter;

in case of determining to update the reference QP of the current level, code the delta QP, and write resulted coded bits into the bitstream.

It will be appreciated that the first memory 2002 in embodiments of the present disclosure may be volatile memory or non-volatile memory, or may include both volatile and non-volatile memories. The nonvolatile memory may be Read-Only Memory (ROM), Programmable ROM (PROM), Erasable PROM (EPROM), Electrically Erasable EPROM (EEPROM), or flash memory. The volatile memory may be a Random Access Memory (RAM) which serves as an external cache. By way of illustration, but not limitation, many forms of RAM are available, such as static random access memory (SRAM), dynamic random access memory (DRAM), synchronous dynamic random access memory (SDRAM), double data rate synchronous dynamic random access memory (DDRSDRAM), enhanced synchronous dynamic random access memory (Enhanced SDRAM, ESDRAM), synchronous connected dynamic random access memory (Synchlink DRAM, SLDRAM), and direct memory bus random access memory (DRRAM). The first memory 2002 of the systems and methods described herein is intended to include but not limited to these and any other suitable types of memory.

The first processor 2003 may be an integrated circuit chip having signal processing capability. In implementation, the steps of the above method may be accomplished by integrated logic circuitry of hardware or instructions in the form of software in the first processor 2003. The first processor 2003 may be a general-purpose processor, a Digital Signal Processor (DSP), an Application Specific Integrated Circuit (ASIC), a Field Programmable Gate Array (FPGA), or other programmable logic device, a discrete gate or transistor logic device, or a discrete hardware component. The methods, steps and logic patch diagrams disclosed in embodiments of the present disclosure may be implemented or performed. The general purpose processor may be a microprocessor or the processor may be any conventional processor or the like. The steps of the method disclosed in combination with the embodiment of the present disclosure can be directly embodied as the execution of the hardware decoding processor or the combined execution of the hardware and software modules in the decoding processor. The software module may be located in RAM, flash memory, read-only memory, programmable read-only memory or electrically erasable programmable memory, registers and other storage media mature in the art. The storage medium is located in the first memory 2002, and the first processor 2003 reads the information in the first memory 2002 and completes the steps of the above method in combination with its hardware.

It will be understood that the embodiments described herein may be implemented in hardware software firmware middleware microcode or a combination thereof. For hardware implementation, the processing unit may be implemented in one or more Application Specific Integrated Circuits (ASIC), Digital Signal Processors (DSPD), Digital Signal Processing Devices (DSPD), Programmable Logic Devices (PLD), Field-Programmable Gate Arrays (FPGA), general purpose processors, controllers, microcontrollers, microprocessors, other electronic units for performing the functions of the present disclosure, or combinations thereof. For software implementations, the techniques of the present disclosure may be implemented by modules (e.g, procedures, functions, etc.) that perform the functions of the present disclosure. The software code may be stored in memory and executed by a processor. The memory can be implemented inside or outside the processor.

Alternatively, in another embodiment, the first processor 2003 is further configured to perform the encoding method of any of the preceding embodiments when running the computer program.

The embodiment provides an encoder in which the signaling overhead in signaling header information can be greatly reduced by modifying the QP signaling and derivation process. Signaling the difference of QPs between different levels, and the corresponding delta QP is coded only when there is a difference. Compared with explicitly signaling the delta QP of each level, the signaling overhead can be reduced, the encoding efficiency can be improved, and code rate can be reduced.

Embodiments of the application further provide a computer-readable storage medium, which stores the bitstream generated by the encoding method of any one of the preceding embodiments. The bitstream is generated by bit coding according to the information to be coded. The information to be coded at least includes: occupation information of current child nodes, etc.

In yet another embodiment of the present disclosure, based on the same inventive concept as the previous embodiments, as illustrated in FIG. 21, a block diagram of the structure of a decoder according to the embodiment of the present disclosure is provided. As illustrated in FIG. 21 the decoder 210 may include a decoding unit 2101 a second determination unit 2102 and a second dequantization unit 2103.

The decoding unit 2101 is configured to decode a prediction parameter of a current level from a bitstream.

The decoding unit 2101 is further configured to decode a delta QP of the current level from the bitstream when the prediction parameter indicates updating a reference QP of the current level.

The second determination unit 2102 is configured to update the reference QP of the current level according to the delta QP, to determine a target QP of the current level.

The second dequantization unit 2103 is configured to dequantize a displacement component according to the target QP of the current level, to determine a reconstructed value of the displacement component of the current level.

It will be understood that the respective functional units of the decoder may further perform the decoding method of any of the foregoing embodiments.

It will be understood that in this embodiment, a “unit” may be part of a circuit, part of a processor, part of a program or software, etc., Of course, it may also be a module, or it may be non-modular. Moreover, the components in the present embodiment may be integrated in one processing unit, or each unit may stand physically alone, or two or more units may be integrated in one unit. The integrated unit can be realized either in the form of hardware or in the form of software function modules.

The integrated unit may be stored in a computer-readable storage medium if it is implemented in the form of a software functional module and is not sold or used as a stand-alone product. Based on this understanding, the present embodiment provides a computer-readable storage medium applied to a decoder 210. The computer-readable storage medium stores a computer program that implements the decoding method of any of the preceding embodiments when executed by a second processor.

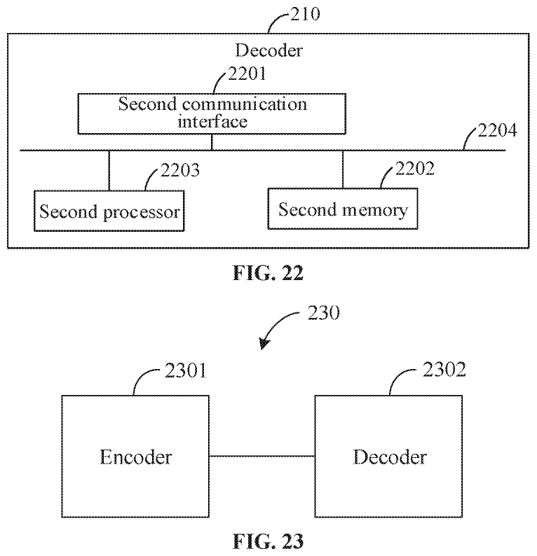

Based on the above-described composition of the decoder 210 and the computer-readable storage medium, as illustrated in FIG. 22, a block diagram of a specific hardware structure of the decoder 210 according to an embodiment of the present disclosure is provided. As illustrated in FIG. 22 the decoder 210 may include a second communication interface 2201 a second memory 2202 and a second processor 2203; The components are coupled together by a second bus system 2204. It can be understood that the second bus system 2204 is used to implement connection communication between these components. The second bus system 2204 includes a power bus, a control bus, and a status signal bus in addition to a data bus. However, for clarity, the various buses are designated as a second bus system 2204 in FIG. 22.

The second communication interface 2201 is configured to receive and transmit signals in the process of sending and receiving information with other external network elements.

A second memory 2202 is configured to store a computer program capable of running on the second processor 2203.

A second processor 2203 is configured to, when running a computer program,
decode a prediction parameter of a current level from a bitstream;
decode a delta QP of the current level from the bitstream when the prediction parameter indicates updating a reference QP of the current level;
update the reference QP of the current level according to the delta QP, to determine a target QP of the current level;
dequantize a displacement component according to the target QP of the current level, to determine a reconstructed value of the displacement component of the current level.

Alternatively, as another embodiment, the second processor 2203 is further configured to perform the decoding method of any of the preceding embodiments when running the computer program.

It will be appreciated that the second memory 2202 is similar in hardware function to the first memory 2002, and the second processor 2203 is similar in hardware function to the first processor 2003, where will not be repeated here.

Embodiments of the present disclosure further provide a computer program product including a computer program or instructions. The computer program or instructions, when executed by the processor, execute the encoding method or decoding method of any of the preceding embodiments.

Embodiments of the present disclosure further provide a decoder in which the signaling overhead in signaling header information can be greatly reduced by modifying the QP signaling and derivation process. Signaling the difference of QPs between different levels, and the corresponding delta QP is decoded only when there is a difference. Compared with explicitly signaling the delta QP of each level, the signaling overhead can be reduced, and the decoding efficiency can be improved.

In yet another embodiment of the present disclosure, as illustrated in FIG. 23, a block diagram of the structure of a codec according to the embodiment of the present disclosure is illustrated. As illustrated in FIG. 23, the codec 230 may include an encoder 2301 and a decoder 2302.

In an embodiment of the present disclosure, the encoder 2301 may be an encoder as described in any of the foregoing embodiments, and the decoder 2302 may be a decoder as described in any of the foregoing embodiments.

It should be noted that, in embodiments of the present disclosure, the terms “including,” “including,” or any other variation thereof are intended to encompass non-exclusive inclusion such that a process, method, article, or apparatus comprising a set of elements includes not only those elements but also other elements not explicitly listed, or also elements inherent to such a process, method, article, or apparatus. In the absence of further limitations, an element defined by the phrase “includes a/an . . . ” does not preclude the existence of another identical element in the process, method, article or device in which it is included.

The above serial numbers of the embodiments of the present disclosure are for description only and do not represent the advantages and disadvantages of the embodiments.

The methods disclosed in several method embodiments provided in the present disclosure can be arbitrarily combined without conflict to obtain new method embodiments.

The features disclosed in several product embodiments provided in the present disclosure can be arbitrarily combined without conflict to obtain new product embodiments.

The features disclosed in several methods or apparatus embodiments provided in the present disclosure can be arbitrarily combined without conflict to obtain new method embodiments or apparatus embodiments.

The above-mentioned is only the specific implementation of the present disclosure, but the scope of protection of the present disclosure is not limited thereto. Any technical person familiar with the technical field who can easily think of changes or substitutions within the technical scope disclosed in the present disclosure should be covered within the scope of protection of the present disclosure. Therefore, the scope of protection of this application shall be subject to the scope of protection of the claims.

### INDUSTRIAL APPLICABILITY

The embodiments of the application provide an encoding and decoding method, an encoder, a decoder and a storage medium. Regardless of whether at an encoding end or a decoding end, a predictive parameter of a current level is determined; a delta QP of the current level is determined in case that the prediction parameter indicates updating a reference QP of the current level; a reference QP of the current level is updated according to the delta QP, to determine a target QP of the current level; a displacement component is dequantized according to the target QP of the current level, to determine a reconstructed value of the displacement component of the current level. In this way, signaling the difference of QPs between different levels, and a corresponding delta QP is coded only when there is a difference. Thus, compared with explicitly signaling the delta QP of each level, the signaling overhead can be reduced, the coding efficiency of the displacement component can be improved, and the code rate can be reduced.

1. A decoding method, applied to a decoder, the method comprising:
decoding a prediction parameter of a current level from a bitstream;
decoding a delta quantization parameter (QP) of the current level from the bitstream, in case that the prediction parameter indicates updating a reference QP of the current level;
updating the reference QP of the current level according to the delta QP, to determine a target QP of the current level; and
dequantizing a displacement component according to the target QP of the current level, to determine a reconstructed value of the displacement component of the current level.

2. The method of claim 1, wherein the prediction parameter comprises a first syntax element indicating whether to update the reference QP of the current level.

3. The method of claim 2, further comprising:
determining to update a reference QP of the current level, in case that the first syntax element indicates updating the reference QP of the current level; and
determining not to update the reference QP of the current level, in case that the first syntax element indicates not updating the reference QP of the current level.

4. The method of claim 3, wherein the first syntax element comprises at least one of the following:
a frame-level first syntax element, or a patch-level first syntax element.

5. The method according to claim 1, further comprising:
determining the reference QP of the current level based on a first QP, wherein the first QP is an initial quantization parameter or a target QP of a reference level of the current level.

6. The method of claim 5, further comprising:
decoding a reference value of the QP from the bitstream; and
determining the initial QP based on the reference value of the QP and a default value of the QP.

7. The method according to claim 6, wherein the default value of the QP is a middle value in a value range of the QP.

8. The method of claim 5, wherein when the current level is a first level, the first QP is the initial QP; and
when the current level is a second level, the first QP is the target QP of the reference level of the current level.

9. The method of claim 8, wherein the first level comprises a current sequence, and the second level comprises at least one of the following: a current LoD, a current frame, or a current patch.

10. The method of claim 8, further comprising:
when the current level is not a third level, determining a reference QP of the next level according to the target QP of the current level; and
when the current level is the third level, dequantizing the displacement component according to the target QP of the current level, to determine a reconstructed value of the displacement component of the current level.

11. The method of claim 1, wherein the delta QP comprises an absolute value of the delta QP and a sign of the delta QP; and
wherein decoding the delta QP of the current level from the bitstream comprises:
decoding the absolute value of the delta QP of the current level from the bitstream; and
when the absolute value of the delta QP is not zero, decoding the sign of the delta QP of the current level from the bitstream.

12. The method of claim 11, wherein updating the reference QP of the current level according to the delta QP to determine the target QP of the current level comprises:
determining a true value of the delta QP according to the absolute value of the delta QP and the sign of the delta QP; and
calculating a sum of the reference QP and the true value of the delta QP to obtain the target QP.

13. An encoding method, applied to an encoder, wherein the method comprises:
determining a delta quantization parameter (QP) of a current level from candidate delta QPs of the current level;
updating a reference QP of the current level according to the delta QP, to determine a target QP of the current level;
dequantizing a displacement component according to the target QP of the current level, to determine a reconstructed value of the displacement component of the current level;
calculating a cost value of the delta QP according to the reconstructed value of the displacement component;
determining an encoding scheme according to the cost value of the delta QP, to determine a prediction parameter of the current level; and
encoding the prediction parameter, and in case of determining to update the reference QP of the current level, encoding the delta QP and writing resulted encoded bits into a bitstream.

14. The method of claim 13, wherein the prediction parameter comprises a first syntax element indicating whether to update the reference QP of the current level.

15. The method of claim 14, further comprising:
in case of determining, according to the determined encoding scheme, to update the reference QP of the current level, using the first syntax element to indicate updating the reference QP of the current level;
in case of determining, according to the determined encoding scheme, that no update of the reference QP of the current level is needed, using the first syntax element to indicate not updating the reference QP of the current level.

16. The method of claim 15, wherein the first syntax element comprises at least one of the following: a frame-level first syntax element, or a patch-level first syntax element.

17. The method of claim 13, further comprising:
determining the reference QP of the current level according to a first QP, wherein the first QP is an initial QP or a target QP of a reference level of the current level.

18. The method of claim 17, wherein further comprising:
determining a reference value of the QP according to an initial QP and a default value of the QP;
coding the reference value of the QP, and writing resulted coded bits into the bitstream.

19. The method of claim 18, wherein the default value of the QP is a middle value in a value range of the QP.

20. A non-transitory computer-readable storage medium having a computer program and a bitstream stored thereon, wherein the computer program, when executed by a processor, enables the processor to perform steps of an encoding method to generate the bitstream, wherein the encoding method comprises:
determining a delta quantization parameter (QP) of a current level from candidate delta QPs of the current level;
updating a reference QP of the current level according to the delta QP, to determine a target QP of the current level;
dequantizing a displacement component according to the target QP of the current level, to determine a reconstructed value of the displacement component of the current level;
calculating a cost value of the delta QP according to the reconstructed value of the displacement component;
determining an encoding scheme according to the cost value of the delta QP, to determine a prediction parameter of the current level; and
encoding the prediction parameter, and in case of determining to update the reference QP of the current level, encoding the delta QP and writing resulted encoded bits into the bitstream.
